(19) United States
(12) Patent Application Publication
(10) Pub. No.: US 2020/0281014 A1
(43) Pub. Date: Sep. 3, 2020

(54) INFORMATION TRANSMISSION METHOD AND APPARATUS FOR GRANT-FREE UPLINKS

(71) Applicant: NTT DOCOMO, INC., Tokyo (JP)

(72) Inventors: Qin MU, Beijing (CN); Liu LIU, Beijing (CN); Wenjia LIU, Beijing (CN); Xiaolin HOU, Beijing (CN)

(73) Assignee: NTT DOCOMO, INC., Tokyo (JP)

(21) Appl. No.: 16/646,699

(22) PCT Filed: Sep. 12, 2018
(86) PCT No.: PCT/CN2018/105198

§ 371 Date: Mar. 12, 2020

(30) Foreign Application Priority Data
Sep. 15, 2017 (CN) 201710833209.X

(51) Int. Cl. H04W 74/00; H04W 72/12; H04L 5/00

(52) U.S. Cl. CPC H04W 74/004; H04L 5/0055; H04L 5/0048; H04W 72/1284

(57) ABSTRACT

An information transmission method is presented for grant-free uplinks. The method as performed by a user terminal includes: transmitting access information of the user terminal; receiving response information of a base station for the access information, the response information including acknowledgment information of the base station to the access information; and when the response information to the access information is received, transmitting service information, the service information including data information.

### TECHNICAL FIELD

The present disclosure relates to a field of wireless communication, and in particular to an information transmission method and an apparatus for grant-free uplinks of a Non-Orthogonal Multiple Access (NOMA) system.

### BACKGROUND

In order to reduce signaling overhead, it has been proposed to utilize grant-free uplinks for information transmission in a NOMA system. In the grant-free uplinks, when a user terminal performs information transmission with a base station, the user terminal transmits, to the base station, uplink access information required for its access to the base station together with data information to be transmitted after accessing the base station. Accordingly, the base station decodes the uplink access information and the data information to obtain the data information.

Specifically, in a communication system, when the base station receives the uplink access information and the data information of the user terminal, the base station firstly decodes the uplink access information. If the decoding is performed correctly, the base station processes the received data information. On the other hand, if the decoding cannot be performed correctly, the base station does not process the received data information.

### SUMMARY OF THE DISCLOSURE

According to one aspect of the present disclosure, an information transmission method for grant-free uplinks performed by a user terminal is provided, the method comprising: transmitting access information of the user terminal; receiving response information of a base station to the access information, wherein the response information includes acknowledgement information of the base station to the access information; transmitting service information after receiving the response information to the access information, wherein the service information includes data information.

According to another aspect of the present disclosure, an information transmission method for grant-free uplinks performed by a base station is provided, the method comprising: receiving access information of a user terminal; decoding the access information of the user terminal, and transmitting response information if the access information is decoded correctly, wherein the response information includes acknowledgement information of the base station to the access information; receiving service information after transmitting the response information, wherein the service information includes data information.

According to another aspect of the present disclosure, a user terminal for grant-free uplinks is provided, the user terminal comprising: a transmitting unit configured to transmit access information of the user terminal; a receiving unit configured to receive response information of a base station to the access information, wherein the response information includes acknowledgement information of the base station to the access information; a determining unit configured to determine whether the receiving unit receives the response information to the access information, the transmitting unit further configured to transmit service information after the determining unit determines that the receiving unit receives the response information to the access information, wherein the service information includes data information.

According to another aspect of the present disclosure, a base station for grant-free uplinks is provided, the base station comprising: a receiving unit configured to receive access information of a user terminal; a decoding unit configured to decode the access information of the user terminal; a determining unit configured to determine whether the decoding is performed correctly; a transmitting unit configured to transmit response information after the determining unit determines that the access information of the user terminal is decoded correctly, wherein the response information includes acknowledgement information of the base station to the access information, the receiving unit further configured to receive service information after the transmitting unit transmits the response information, wherein the service information includes data information.

With the information transmission method and the apparatus for grant-free uplinks according to the above aspects of the present disclosure, invalid transmission of the service information is avoided, and thus waste of radio resources is reduced and uplink spectral efficiency is improved.

### BRIEF DESCRIPTION OF THE DRAWINGS

In order to explain the technical solution of embodiments of the present disclosure more clearly, accompanying drawings used in description of the embodiments will be briefly introduced below. Obviously, the accompanying drawings in the following description are merely some of the embodiments of the present disclosure. Those skilled in the art may further obtain other accompanying drawings according to these accompanying drawings without creative effort.

FIG. 1 shows a flowchart of an information transmission method for grant-free uplinks performed by a user terminal according to one embodiment of the present disclosure;

FIG. 2 shows a schematic diagram of information transmission between a user terminal and a base station according to one example;

FIG. 3 shows a schematic diagram of information transmission between a user terminal and a base station according to another example;

FIG. 4 shows a schematic diagram of information transmission between a user terminal and a base station according to another example;

FIG. 5 shows a schematic diagram of information transmission between a user terminal and a base station according to another example;

FIG. 6 shows a schematic diagram of information transmission between a user terminal and a base station according to another example;

FIG. 7 shows a flowchart of an information transmission method for grant-free uplinks performed by a base station according to one embodiment of the present disclosure;

FIG. 8 shows a schematic structural diagram of a user terminal performing the method shown in FIG. 1 according to the embodiments of the present disclosure;

FIG. 9 shows a schematic structural diagram of a base station performing the method shown in FIG. 7 according to the embodiments of the present disclosure;

FIG. 10 shows a schematic diagram of a hardware structure of a related user equipment according to the embodiments of the present disclosure.

### DESCRIPTION OF THE EMBODIMENTS

An information transmission method and an apparatus for grant-free uplinks according to embodiments of the present disclosure will be described below with reference to the accompanying drawings. Like reference numerals refer to like elements throughout the accompanying drawings. It should be understood that the embodiments described herein are merely illustrative and should not be construed as limiting the scope of the present disclosure. Furthermore, the base station may be a fixed station, a NodeB, an eNodeB (eNB), an access point, a transmission point, a reception point, a femto cell, a small cell and the like, which is not limited herein. Furthermore, a User Equipment (UE) described herein may include various types of user terminals, for example, a mobile terminal (or referred to as a mobile station) or a fixed terminal. However, for convenience, the UE and the mobile station sometimes may be used interchangeably hereinafter.

According to the information transmission method and the apparatus for grant-free uplinks provided by the embodiments of the present disclosure, the user terminal firstly transmits access information to the base station, and the user terminal transmits service information only after receiving the base station acknowledgement information to the access information, thereby avoiding invalid transmission of the service information, and thus reducing waste of radio resources and improving uplink spectral efficiency.

The information transmission method for grant-free uplinks performed by a user terminal according to one embodiment of the present disclosure will be described below with reference to FIG. 1. FIG. 1 illustrates a flowchart of the information transmission method 100 for grant-free uplinks.

As shown in FIG. 1, in step S101, access information of a user terminal is transmitted. According to one example of the embodiment, the access information may include a preamble code (also referred to as a preamble sequence or a random access preamble code) and/or uplink data control information.

For example, the preamble code may include a cyclic prefix CP with a length of Tcp and a sequence with a length of Tseq. For a cell formed by a base station, there may be 64 preamble codes. When accessing to the base station, the user terminal selects one of the 64 preamble codes for access to prevent access collisions with other user terminals.

Furthermore, the preamble code may further include identification information of the user terminal. The identification information of the user terminal may be, for example, the user terminal's ID, the user terminal's physical address (also referred to as Media Access Control (MAC) address), or other information that can uniquely identify the user terminal and the like, to identify the user terminal's identity. After receiving the preamble code of the user terminal, the base station may obtain the identification information of the user terminal from the preamble code, thereby identifying the user terminal's identity.

As another example, the uplink data control information may include Uplink Control CHannel (UL CCH) information of the user terminal.

As described above, the access information transmitted in step S101 may include both a preamble code and uplink data control information. Alternatively, the access information transmitted in step S101 may also include only one of a preamble code and uplink data control information.

When the access information includes a preamble code and uplink data control information, both the preamble code and the uplink data control information may include the identification information of the user terminal, or one of the two may include the identification information of the user terminal, to identify the user terminal's identity.

Furthermore, when the access information includes only uplink data control information, the uplink data control information may include the identification information of the user terminal. As described above, the identification information of the user terminal may be, for example, the user terminal's ID, the user terminal's MAC address, or other information that can uniquely identify the user terminal and the like, to identify the user terminal's identity. After receiving the uplink data control information of the user terminal, the base station may obtain the identification information of the user terminal from the uplink data control information, thereby identifying the user terminal's identity.

According to another example of this embodiment, the access information in step S101 may further include first scheduling information for the service information. The service information will be further described in a later step S103.

According to an example of this embodiment, the first scheduling information may include at least one of modulation and coding information for the service information, information on the number of times of retransmissions for the service information, transmission power control information for the service information, signature information for the service information, reference signal information for the service information, and radio resource information for the service information. After receiving the first scheduling information, the base station may process the service information transmitted by the user terminal according to the first scheduling information.

For example, the modulation and coding information for the service information may indicate a modulation and coding mode adopted by the user terminal when transmitting the service information, so that the base station may demodulate and decode the service information according to the modulation and coding information after receiving the service information.

As another example, the information on the number of times of retransmissions for the service information may indicate the number of times of retransmissions after the user terminal failing to transmit the service information, so that the base station may perform hybrid feedback retransmission combination on the service information received for multiple times.

As yet another example, the transmission power control information for the service information may indicate a transmission power adopted by the user terminal when transmitting the service information, so that the base station may obtain the transmission power for the user terminal, and thereby perform channel measurement or channel estimation.

As yet another example, the signature information for the service information may indicate an interleaving mode adopted by the user terminal when transmitting the service information, so that the base station may recover information before interleaving according to the interleaving mode after receiving the service information (this operation may also be referred to as □de-interleaving□). The signature information for the service information may also indicate a scrambling mode adopted by the user terminal when transmitting the service information, so that the base station may recover information before scrambling according to the scrambling mode after receiving the service information (this operation may also be referred to as □de-scrambling□). The signature information for the service information may also indicate a spreading mode adopted by the user terminal when transmitting the service information, so that the base station may recover information before spreading according to the spreading mode after receiving the service information. Certainly, the signature information for the service information is not limited to the interleaving mode, the scrambling mode, and the spreading mode listed herein, and may also indicate other operations that the user terminal performs on the service information when transmitting the service information.

As yet another example, the reference signal information for the service information may indicate reference signals of a channel adopted by the user terminal when transmitting the service information, so that the base station may perform channel measurement or channel estimation.

As yet another example, the radio resource information for the service information may indicate radio resources occupied by the user terminal when transmitting the service information, so that the base station may receive the service information on the radio resources.

Then, in step S102, response information of the base station to the access information is received, where the response information includes acknowledgement information (also referred to as □ACK□) of the base station to the access information. In this embodiment, when the base station decodes the access information correctly, the base station may feed back the acknowledgement information to the user terminal. On the other hand, when the base station does not decode the access information correctly, the base station may not feed back any information to the user terminal, or may feed back non-acknowledgment information (also referred to as □NACK□) to the user terminal.

According to one example of this embodiment, when the access information transmitted by the user terminal in step S101 includes a preamble code, the user terminal receives response information of the base station to the preamble code in step S102, where the response information includes acknowledgement information of the base station to the preamble code. For example, when the user terminal transmits the preamble code in step S101, the base station receives and decodes the preamble code. If the decoding is performed correctly, the base station may feed back acknowledgement information to the user terminal, and the user terminal receives the acknowledgement information of the base station to the preamble code in step S102. In this example, a correct decoding may be that the base station obtains the identification information of the user terminal through the decoding and thereby identifies the user terminal's identity.

According to another example of this embodiment, when the access information transmitted by the user terminal in step S101 includes uplink data control information, the user terminal receives response information of the base station to the uplink data control information in step S102, where the response information includes acknowledgement information of the base station to the uplink data control information. For example, when the user terminal transmits the uplink data control information in step S101, the base station receives and decodes the uplink data control information. If the decoding is performed correctly, the base station may feed back acknowledgement information to the user terminal, and the user terminal receives the acknowledgement information of the base station to the uplink data control information in step S102.

According to another example of this embodiment, when the access information transmitted by the user terminal in step S101 includes a preamble code and uplink data control information, the user terminal receives response information of the base station to the preamble code and the uplink data control information in step S102, where the response information includes acknowledgement information of the base station to the preamble code and the uplink data control information. For example, when the user terminal transmits the preamble code and the uplink data control information in step S101, the base station receives and decodes the preamble code and the uplink data control information. If the decoding is performed correctly, the base station may feed back acknowledgement information to the user terminal, and the user terminal receives the acknowledgement information of the base station to the preamble code and the uplink data control information in step S102.

In this example, the base station feeds back the acknowledgement information to the user terminal only after correctly decoding the preamble code and the uplink data control information, respectively.

In addition, according to another example of this embodiment, the response information received by the user terminal in step S102 may further include Timing Advance (TA) information transmitted by the base station to the user terminal. For example, the base station may transmit a timing advance command to the user terminal to inform the user terminal of the amount of time of the timing advance, thereby avoiding transmission delay caused by the distance between the base station and the user terminal, and reducing interference between the user terminal and other user terminals.

Furthermore, according to another example of this embodiment, when the user terminal transmits the first scheduling information for the service information in step S101, the base station receives the first scheduling information for the service information. Then, the base station generates modified scheduling information according to the first scheduling information for the service information, and feeds back the modified scheduling information to the user terminal by including it in the response information. Accordingly, the user terminal receives the modified scheduling information in step S102.

For example, when the user terminal transmits scheduling information for the service information in step S101, the base station receives the scheduling information for the service information. Then, the base station may flexibly modify the received scheduling information based on load conditions, channel conditions and the like in the cell to obtain the modified scheduling information. The base station may then feed back the modified scheduling information to the user terminal by including it in the response information. Accordingly, the user terminal receives the modified scheduling information in step S102. Then, the user terminal transmits the service information to the base station based on the modified scheduling information in a later step S103.

For example, the scheduling information transmitted by the user terminal in step S101 may include the modulation and coding information for the service information. When the user terminal transmits the modulation and coding information for the service information in step S101, the base station receives the modulation and coding information for the service information. Then, the base station may select a preferable coding and modulation mode for the user terminal based on load conditions, channel conditions and the like in the cell, to obtain information on the preferable modulation and coding mode. Then, the base station may feed back the information on the preferable modulation and coding mode to the user terminal by including it in the response information. Accordingly, the user terminal receives the information on the preferable modulation and coding mode in step S102. Then, the user terminal transmits the service information to the base station based on the preferable modulation and coding mode in a later step S103.

Similarly, the scheduling information transmitted by the user terminal in step S101 may include information on the number of times of retransmissions for the service information, transmission power control information for the service information, signature information for the service information, reference signal information for the service information, or radio resource information for the service information and the like. That is, the base station may select the number of times of retransmissions, a transmission power, a signature mode, radio resources and the like that are preferable for the user terminal based on load conditions, channel conditions and the like in the cell.

Certainly, the base station may also select a modulation and coding mode, the number of times of retransmissions, a transmission power, a signature mode, radio resources and the like that are inferior for the user terminal based on load conditions, channel conditions and the like in the cell, which sacrifices part of the user terminal performance while realizes an overall performance improvement of the cell.

According to another example of this embodiment, the base station may further transmit second scheduling information to the user terminal. For example, when the user terminal transmits the first scheduling information for the service information in step S101, the response information received by the user terminal in step S102 may further include the second scheduling information. Specifically, the second scheduling information may be supplementary information of the base station to the first scheduling information.

For example, when the user terminal transmits only the modulation and coding information in the scheduling information for the service information in step S101, the response information received by the user terminal in step S102 may include other information in the scheduling information for the service information, such as information on the number of times of retransmissions, transmission power control information for the service information, signature information for the service information, reference signal information for the service information, radio resource information for the service information, and the like.

According to another example of this embodiment, when the user terminal transmits the first scheduling information for the service information in step S101, the response information received by the user terminal in step S102 may include not only the modified first scheduling information, but also the second scheduling information.

For example, when the user terminal transmits only the modulation and coding information in the scheduling information for the service information in step S101, the base station modifies the modulation and coding information after receiving it to obtain modified modulation and coding information, and thus the response information received by the user terminal in step S102 may include not only other information in the scheduling information for the service information, such as information on the number of times of retransmissions, transmission power control information for the service information, signature information for the service information, reference signal information for the service information, radio resource information for the service information and the like, but also the modified modulation and coding information.

The specific content of the response information received by the user terminal in step S102 has been described above, and the time that the user terminal receives the response information in step S102 will be described below. In this embodiment, the time that the user terminal receives the response information in step S102 may be a moment or a time window.

According to an example of this embodiment, the user terminal may transmit information indicating a first time interval to the base station when transmitting the access information of the user terminal in step S101. The base station may transmit the response information to the access information after the first time interval according to the received access information. For example, after receiving the access information, the base station may transmit the response information of the base station to the access information at a moment or any moment in a time window after a predetermined time interval. Accordingly, after step S101, the user terminal may receive the response information of the base station to the access information at a moment or in a time window after the first time interval.

According to another example of this embodiment, the user terminal may also determine a periodic information-receiving window, and receive the response information of the base station to the access information in a first information-receiving window after transmitting the access information of the user terminal in step S101. The information-receiving window may be a time window for transmitting signaling between the user terminal and the base station. Alternatively, the information-receiving window may be a time period.

In this example, the signaling transmitted in the time window may include user terminal-specific signaling information transmitted by the base station to the user terminal, or group-specific signaling information of a user terminal group to which the user terminal belongs. The user terminal-specific signaling may include cell reference signals, downlink control information and the like; the group-specific signaling information may include channel quality conditions, resource allocation conditions, user terminal grouping conditions, and so on.

The user terminal group mentioned herein may include one or more user terminals transmitting signaling information in a same time slot, or may include one or more user terminals transmitting signaling information in a same frequency band, or may be one or more user terminals that transmit access information within a time period between two adjacent information-receiving windows.

Furthermore, according to another example of this embodiment, the base station may transmit the response information to the access information on an existing downlink channel, or may transmit the response information to the access information on a dedicated channel.

Specifically, the base station may transmit the response information to the access information on a downlink control channel, a downlink data channel, or a response information transmission channel. Accordingly, the user terminal receives the response information of the base station to the access information on the corresponding downlink control channel, the downlink data channel, or the response information transmission channel in step S102.

For example, the downlink control channel may include a Physical Downlink Control Channel (PDCCH), a Physical Multicast Channel (PMCH), a Physical Broadcast Channel (PBCH), a Physical Control Format Indicator Channel (PCFICH), and a Physical HARQ Indicator Channel (PHICH) and the like; the downlink data channel may include a Physical Downlink Shared Channel (PDSCH) and the like; the response information transmission channel may include a channel dedicated to receive the response information.

According to another example of this embodiment, in step S102, the user terminal may determine radio resources carrying the response information based on at least one of the identification information of the user terminal and information on radio resources for transmitting the uplink data control information, and then receive the response information of the base station to the access information on the radio resources.

For example, the base station determines, for user terminals in the cell, a radio resource pool for transmitting response information. After receiving access information of a certain user terminal, the base station selects radio resources for the user terminal, and then transmits response information to the access information of this user terminal on the radio resources. In step S102, the user terminal may deduce index numbers of radio resources used by the base station based on the identification information of the user terminal, and then receive the response information on the radio resources corresponding to the index numbers.

As another example, the base station determines, for user terminals in the cell, a radio resource pool for transmitting response information. After receiving access information of a user terminal, the base station selects radio resources for the user terminal, and then transmits response information to the access information of this user terminal on the radio resources. In step S102, the user terminal may deduce index numbers of radio resources used by the base station not only based on the identification information of the user terminal but also based on the information on radio resources for transmitting the uplink data control information, and then receive the response information on the radio resources corresponding to the index numbers.

In this example, the base station may use frequency resources for transmitting the uplink data control information as frequency resources for transmitting the response information. That is, frequency resources for transmitting the uplink data control information and frequency resources for transmitting the response information may be identical. Alternatively, the base station may also use a subframe pattern corresponding to radio resources for transmitting the uplink data control information as a subframe pattern for transmitting the response information. That is, a subframe pattern for transmitting the uplink data control information and a subframe pattern for transmitting the response information may be identical.

Then, in step S103, after the response information to the access information is received, the service information is transmitted, where the service information includes data information. In this embodiment, the user terminal transmits the service information only after receiving the response information of the base station to the access information, thereby avoiding waste of radio resources.

According to one example of this embodiment, if the access information transmitted by the user terminal in step S101 includes a preamble code and then the user terminal receives response information of the base station to the preamble code in step S102, the user terminal may transmit the data information in step S103.

According to another example of this embodiment, if the access information transmitted by the user terminal in step S101 includes uplink data control information and then the user terminal receives response information of the base station to the uplink data control information in step S102, the user terminal may transmit the data information in step S103.

According to another example of this embodiment, if the access information transmitted by the user terminal in step S101 includes a preamble code and uplink data control information and then the user terminal receives response information of the base station to the preamble code and the uplink data control information in step S102, the user terminal may transmit the data information in step S103.

According to another example of this embodiment, if the access information transmitted by the user terminal in step S101 includes a preamble code and then the user terminal receives response information of the base station to the preamble code in step S102, the user terminal may also transmit uplink data control information and the data information in step S103.

According to another example of this embodiment, if the access information transmitted by the user terminal in step S101 includes a preamble code and then the user terminal receives response information of the base station to the preamble code in step S102, the user terminal may also transmit uplink data control information firstly, receive response information of the base station to the uplink data control information that includes acknowledgement information of the base station to the uplink data control information, and then transmit service information after receiving the response information of the uplink data control information in step S103.

The specific process of the user terminal transmitting the service information in step S103 has been described above, and the time that the user terminal transmits the service information in step S103 will be described below.

According to one example of this embodiment, the user terminal may transmit information indicating a second time interval to the base station when transmitting the access information of the user terminal in step S101. After receiving the response information, the user terminal may transmit the service information to the base station after the second time interval, so that the base station receives the service information transmitted by the user terminal at a corresponding moment. For example, after receiving the response information, the user terminal may transmit the service information at a moment or any moment in a time window after a predetermined time interval.

According to another example of this embodiment, the user terminal may not transmit information indicating the second time interval to the base station. Specifically, after receiving the response information, the user terminal may transmit the service information after a third time interval.

As for the □first time interval□, the □second time interval□ and the □third time interval□ mentioned above, time lengths corresponding to them may be the same or different, which is not limited by this embodiment.

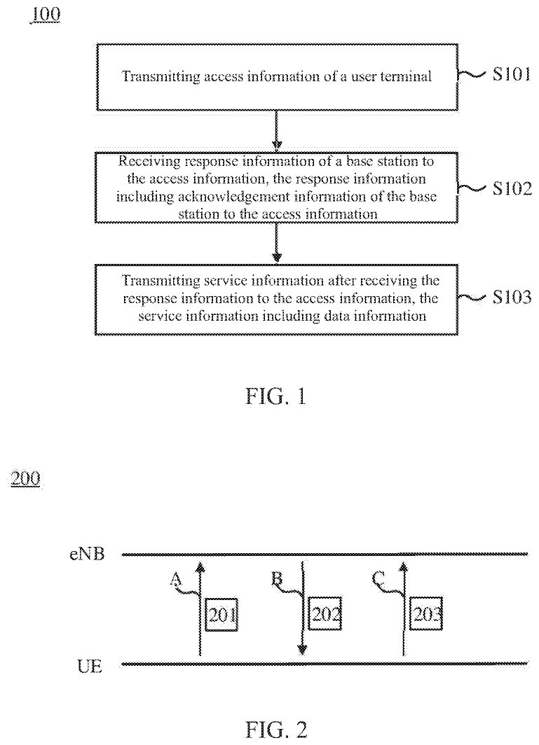

Steps S101-103 have been described in detail above, and examples of the method 100 will be further described below with reference to FIGS. 2-6.

FIG. 2 shows a schematic diagram of information transmission between a user terminal and a base station according to one example. In the example shown in FIG. 2, the access information includes a preamble code 201 and the service information includes data information 203. As shown in FIG. 2, firstly, as shown by arrow A, the user terminal transmits the preamble code 201 to the base station. Then, as shown by arrow B, the user terminal receives, from the base station, response information 202 of the base station to the preamble code 201. Finally, as shown by arrow C, the user terminal transmits the data information 203 to the base station.

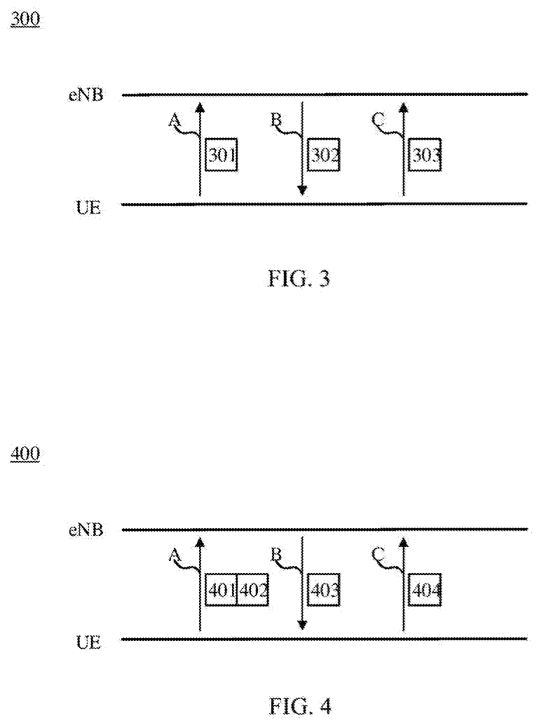

FIG. 3 shows a schematic diagram of information transmission between a user terminal and a base station according to another example. In the example shown in FIG. 3, the access information includes uplink data control information 301 and the service information includes data information 303. As shown in FIG. 3, firstly, as shown by arrow A, the user terminal transmits the uplink data control information 301 to the base station. Then, as shown by arrow B, the user terminal receives, from the base station, response information 302 of the base station to the uplink data control information 301. Finally, as shown by arrow C, the user terminal transmits the data information 303 to the base station.

FIG. 4 shows a schematic diagram of information transmission between a user terminal and a base station according to another example. In the example shown in FIG. 4, the access information includes a preamble code 401 and uplink data control information 402, and the service information includes data information 404. As shown in FIG. 4, firstly, as shown by arrow A, the user terminal transmits the preamble code 401 and the uplink data control information 402 to the base station. Then, as shown by arrow B, the user terminal receives, from the base station, response information 403 of the base station to the preamble code 401 and the uplink data control information 402. Finally, as shown by arrow C, the user terminal transmits the data information 404 to the base station.

FIG. 5 shows a schematic diagram of information transmission between a user terminal and a base station according to another example. In the example shown in FIG. 5, the access information includes a preamble code 501, and the service information includes uplink data control information 503 and data information 504. As shown in FIG. 5, firstly, as shown by arrow A, the user terminal transmits the preamble code 501 to the base station. Then, as shown by arrow B, the user terminal receives, from the base station, response information 502 of the base station to the preamble code 501. Finally, as shown by arrow C, the user terminal transmits the uplink data control information 503 and the data information 504 to the base station.

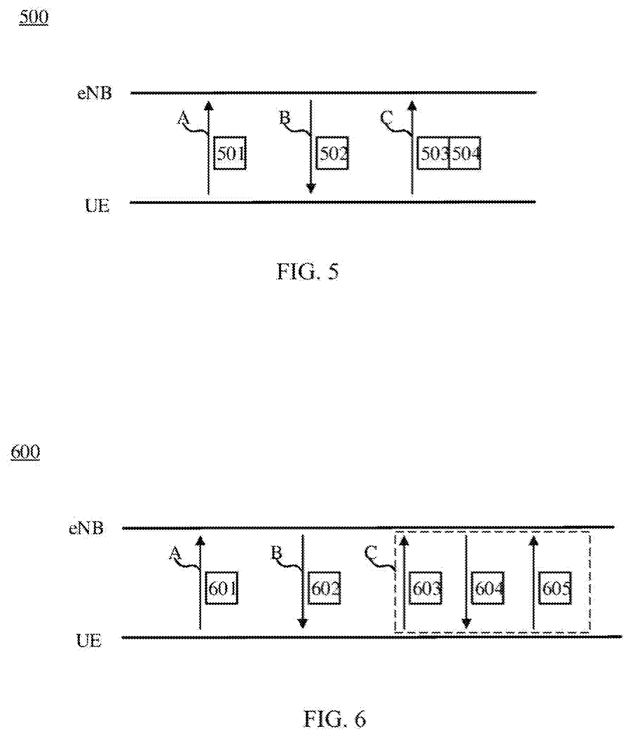

FIG. 6 shows a schematic diagram of information transmission between a user terminal and a base station according to another example. In the example shown in FIG. 6, the access information includes a preamble code 601 and the service information includes data information 605. As shown in FIG. 6, firstly, as shown by arrow A, the user terminal transmits the preamble code 601 to the base station. Then, as shown by arrow B, the user terminal receives, from the base station, response information 602 of the base station to the preamble code 601. Finally, as shown by arrow C, the user terminal firstly transmits uplink data control information 603 to the base station, receives response information 604 of the base station to the uplink data control information 603, and finally transmits the data information 605 after receiving the response information 604 of the uplink data control information.

According to the information transmission method for grant-free uplinks performed by a user terminal provided by the embodiments of the present disclosure, the user terminal firstly transmits the access information to the base station, and the user terminal transmits the service information only after receiving the base station acknowledgement information to the access information, thereby avoiding invalid transmission of the service information, and thus reducing waste of radio resources and improving uplink spectral efficiency.

An information transmission method for grant-free uplinks performed by a base station according to one embodiment of the present disclosure will be described below with reference to FIG. 7. FIG. 7 shows a flowchart of the information transmission method 700 for grant-free uplinks.

As shown in FIG. 7, in step S701, access information of a user terminal is received. According to one example of this embodiment, the access information may include a preamble code (also referred to as a preamble sequence or a random access preamble code) and/or uplink data control information.

For example, the preamble code may include a cyclic prefix CP with a length of Tcp and a sequence with a length of Tseq. For a cell formed by a base station, there may be 64 preamble codes. When accessing to the base station, the user terminal selects one of the 64 preamble codes for access to prevent access collisions with other user terminals.

Furthermore, the preamble code may further include identification information of the user terminal. The identification information of the user terminal may be, for example, the user terminal's ID, the user terminal's physical address (also referred to as Media Access Control (MAC) address), or other information that can uniquely identify the user terminal and the like, to identify the user terminal's identity. After receiving the preamble code of the user terminal, the base station may obtain the identification information of the user terminal from the preamble code, thereby identifying the user terminal's identity.

As another example, the uplink data control information may include Uplink Control CHannel (ULCCH) information of the user terminal.

As described above, the access information received in step S701 may include both a preamble code and uplink data control information. Alternatively, the access information received in step S701 may also include only one of a preamble code and uplink data control information.

When the access information includes a preamble code and uplink data control information, both the preamble code and the uplink data control information may include the identification information of the user terminal, or one of the two may include the identification information of the user terminal, to identify the user terminal's identity.

Furthermore, when the access information includes only uplink data control information, the uplink data control information may include the identification information of the user terminal. As described above, the identification information of the user terminal may be, for example, the user terminal's ID, the user terminal's MAC address, or other information that can uniquely identify the user terminal and the like, to identify the user terminal's identity. After receiving the uplink data control information of the user terminal, the base station may obtain the identification information of the user terminal from the uplink data control information, thereby identifying the user terminal's identity.

According to another example of this embodiment, the access information in step S701 may further include first scheduling information for the service information. The service information will be further described in a later step S703.

According to an example of this embodiment, the first scheduling information may include at least one of modulation and coding information for the service information, information on the number of times of retransmissions for the service information, transmission power control information for the service information, signature information for the service information, reference signal information for the service information, and radio resource information for the service information. After receiving the first scheduling information, the base station may process the service information transmitted by the user terminal according to the first scheduling information.

For example, the modulation and coding information for the service information may indicate a modulation and coding mode adopted by the user terminal when transmitting the service information, so that the base station may demodulate and decode the service information according to the modulation and coding information after receiving the service information.

As another example, the information on the number of times of retransmissions for the service information may indicate the number of times of retransmissions after the user terminal failing to transmit the service information, so that the base station may perform hybrid feedback retransmission combination on the service information received for multiple times.

As yet another example, the transmission power control information for the service information may indicate a transmission power adopted by the user terminal when transmitting the service information, so that the base station may obtain the transmission power for the user terminal, and thereby perform channel measurement or channel estimation.

As yet another example, the signature information for the service information may indicate an interleaving mode adopted by the user terminal when transmitting the service information, so that the base station may recover information before interleaving according to the interleaving mode after receiving the service information (this operation may also be referred to as □de-interleaving□). The signature information for the service information may also indicate a scrambling mode adopted by the user terminal when transmitting the service information, so that the base station may recover information before scrambling according to the scrambling mode after receiving the service information (this operation may also be referred to as □de-scrambling□). The signature information for the service information may also indicate a spreading mode adopted by the user terminal when transmitting the service information, so that the base station may recover information before spreading according to the spreading mode after receiving the service information. Certainly, the signature information for the service information is not limited to the interleaving mode, the scrambling mode, and the spreading mode listed herein, and may also indicate other operations that the user terminal performs on the service information when transmitting the service information.

As yet another example, the reference signal information for the service information may indicate reference signals of a channel adopted by the user terminal when transmitting the service information, so that the base station may perform channel measurement or channel estimation.

As yet another example, the radio resource information for the service information may indicate radio resources occupied by the user terminal when transmitting the service information, so that the base station may receive the service information on the radio resources.

Then, in step S702, the access information of the user terminal is decoded, and response information is transmitted if decoded correctly, where the response information includes acknowledgement information (also referred to as □ACK□) of the base station to the access information. In this embodiment, when the base station decodes the access information correctly, the base station may feed back the acknowledgement information to the user terminal. On the other hand, when the base station does not decode the access information correctly, the base station may not feed back any information to the user terminal, or may feed back non-acknowledgment information (also referred to as □NACK□) to the user terminal.

According to one example of this embodiment, when the access information received by the base station in step S701 includes a preamble code, the base station decodes the preamble code of the user terminal in step S702 and transmits response information if decoding correctly, where the response information includes acknowledgement information of the base station to the preamble code. For example, after the base station receiving the preamble code in step S701, the base station decodes the preamble code in step S702 and feeds back acknowledgement information to the user terminal if decoding correctly. In this example, a correct decoding may be that the base station obtains the identification information of the user terminal through the decoding and thereby identifies the user terminal's identity.

According to another example of this embodiment, when the access information received by the base station in step S701 includes uplink data control information, the base station decodes the uplink data control information of the user terminal in step S702 and transmits response information if decoding correctly, where the response information includes acknowledgement information of the base station to the uplink data control information. For example, after the base station receives the uplink data control information in step S701, the base station decodes the uplink data control information in step S702 and feeds back acknowledgement information to the user terminal if decoding correctly.

According to another example of this embodiment, when the access information received by the base station in step S701 includes a preamble code and uplink data control information, the base station decodes the preamble code and the uplink data control information of the user terminal in step S702 and transmits response information if decoding correctly, where the response information includes acknowledgement information of the base station to the preamble code and the uplink data control information. For example, after the base station receives the preamble code and the uplink data control information in step S701, the base station decodes them in step S702 and feeds back acknowledgement information to the user terminal if decoding correctly.

In this example, the base station feeds back the acknowledgement information to the user terminal only after correctly decoding the preamble code and the uplink data control information, respectively, in step S702.

In addition, according to another example of this embodiment, the response information transmitted by the base station in step S702 may further include Timing Advance (TA) information transmitted by the base station to the user terminal. For example, the base station may transmit a timing advance command to the user terminal to inform the user terminal of the amount of time of the timing advance, thereby avoiding transmission delay caused by the distance between the base station and the user terminal, and reducing interference between the user terminal and other user terminals.

Furthermore, according to another example of this embodiment, when the base station receives the first scheduling information for the service information in step S701, the base station generates modified scheduling information according to the first scheduling information for the service information, and feeds back the modified scheduling information to the user terminal in step S702 by including it in the response information.

For example, when the user terminal transmits scheduling information for the service information, the base station receives the scheduling information for the service information. Then, the base station may flexibly modify the received scheduling information based on load conditions, channel conditions and the like in the cell to obtain the modified scheduling information. The base station may then feed back the modified scheduling information to the user terminal by including it in the response information. Accordingly, the user terminal receives the modified scheduling information. Then, the user terminal may transmit the service information to the base station based on the modified scheduling information.

For example, the scheduling information received by the base station in step S701 may include the modulation and coding information for the service information, and then the base station may select a preferable coding and modulation mode for the user terminal based on load conditions, channel conditions and the like in the cell, to obtain information on the preferable modulation and coding mode. Then, the base station may feed back the information on the preferable modulation and coding mode to the user terminal in step S702 by including it in the response information. After receiving the information on the preferable modulation and coding mode, the user terminal may transmit the service information to the base station based on the preferable modulation and coding mode.

Similarly, the scheduling information received by the base station in step S701 may include information on the number of times of retransmissions for the service information, transmission power control information for the service information, signature information for the service information, reference signal information for the service information, or radio resource information for the service information and the like. That is, the base station may select the number of times of retransmissions, a transmission power, a signature mode, radio resources and the like that are preferable for the user terminal based on load conditions, channel conditions and the like in the cell.

Certainly, the base station may also select a modulation and coding mode, the number of times of retransmissions, a transmission power, a signature mode, radio resources and the like that are inferior for the user terminal based on load conditions, channel conditions and the like in the cell, which sacrifices part of the user terminal performance while realizes an overall performance improvement of the cell.

According to another example of this embodiment, the base station may further transmit second scheduling information to the user terminal in step S702. For example, when the base station receives the first scheduling information for the service information in step S701, the base station may generate the second scheduling information, and the response information transmitted in step S702 may further include the second scheduling information. Specifically, the second scheduling information may be supplementary information of the base station to the first scheduling information.

For example, when the base station receives only the modulation and coding information in the scheduling information for the service information in step S701, the response information transmitted by the base station in step S702 may include other information in the scheduling information for the service information, such as information on the number of times of retransmissions, transmission power control information for the service information, signature information for the service information, reference signal information for the service information, radio resource information for the service information, and the like.

According to another example of this embodiment, when the base station receives the first scheduling information for the service information in step S701, the response information transmitted by the base station in step S702 may include not only the modified first scheduling information, but also the second scheduling information.

For example, when the base station receives only the modulation and coding information in the scheduling information for the service information in step S701, the base station modifies the modulation and coding information after receiving it to obtain modified modulation and coding information, and thus the response information transmitted by the base station in step S702 may include not only other information in the scheduling information for the service information, such as information on the number of times of retransmissions, transmission power control information for the service information, signature information for the service information, reference signal information for the service information, radio resource information for the service information and the like, but also the modified modulation and coding information.

The specific content of the response information transmitted by the base station in step S702 has been described above, and the time that the base station transmits the response information in step S702 will be described below. In this embodiment, the time that the base station transmits the response information in step S702 may be a moment or a time window.

According to an example of this embodiment, the base station may further receive information indicating a first time interval in step S701. After receiving the access information, the base station may transmit the response information to the access information after the first time interval. For example, after receiving the access information, the base station may transmit the response information of the base station to the access information at a moment or any moment in a time window after a predetermined time interval. Accordingly, the user terminal may receive the response information of the base station to the access information at a moment or in a time window after the first time interval.

According to another example of this embodiment, the base station may also determine a periodic information-receiving window, and transmit the response information of the base station to the access information in a first information-receiving window after receiving the access information of the user terminal in step S701. The information-receiving window may be a time window for transmitting signaling between the user terminal and the base station. Alternatively, the information-receiving window may be a time period.

In this example, the signaling transmitted in the time window may include user terminal-specific signaling information transmitted by the base station to the user terminal, or group-specific signaling information of a user terminal group to which the user terminal belongs. The user terminal-specific signaling may include cell reference signals, downlink control information and the like; the group-specific signaling information may include channel quality conditions, resource allocation conditions, user terminal grouping conditions, and so on.

The user terminal group mentioned herein may include one or more user terminals transmitting signaling information in a same time slot, or may include one or more user terminals transmitting signaling information in a same frequency band, or may be one or more user terminals that transmit access information within a time period between two adjacent information-receiving windows.

Furthermore, according to another example of this embodiment, the base station may transmit the response information to the access information on an existing downlink channel, or may transmit the response information to the access information on a dedicated channel.

Specifically, in step S702, the base station may transmit the response information to the access information on a downlink control channel, a downlink data channel, or a response information transmission channel. Accordingly, the user terminal receives the response information of the base station to the access information on the corresponding downlink control channel, the downlink data channel, or the response information transmission channel.

For example, the downlink control channel may include a Physical Downlink Control Channel (PDCCH), a Physical Multicast Channel (PMCH), a Physical Broadcast Channel (PBCH), a Physical Control Format Indicator Channel (PCFICH), and a Physical HARQ Indicator Channel (PHICH) and the like; the downlink data channel may include a Physical Downlink Shared Channel (PDSCH) and the like; the response information transmission channel may include a channel dedicated to receive the response information.

According to another example of this embodiment, in step S702, the base station may determine radio resources carrying the response information based on at least one of the identification information of the user terminal and information on radio resources for transmitting the uplink data control information, and then transmit the response information of the base station to the access information on the radio resources.

For example, the base station determines, for user terminals in the cell, a radio resource pool for transmitting response information. After receiving access information of a user terminal, the base station selects radio resources for the user terminal, and then transmits response information to the access information of this user terminal on the radio resources. In step S702, the base station may deduce index numbers of radio resources used by the base station based on the identification information of the user terminal, and then transmit the response information on the radio resources corresponding to the index numbers.

As another example, the base station determines, for user terminals in the cell, a radio resource pool for transmitting response information. After receiving access information of a user terminal, the base station selects radio resources for the user terminal, and then transmits response information to the access information of this user terminal on the radio resources. In step S702, the base station may deduce index numbers of radio resources used by the base station not only based on the identification information of the user terminal but also based on the information on radio resources for transmitting the uplink data control information, and then transmit the response information on the radio resources corresponding to the index numbers.

In this example, the base station may use frequency resources for transmitting the uplink data control information as frequency resources for transmitting the response information. That is, frequency resources for transmitting the uplink data control information and frequency resources for transmitting the response information may be identical. Alternatively, the base station may also use a pattern corresponding to radio resources for transmitting the uplink data control information as a subframe pattern for transmitting the response information. That is, a subframe pattern for transmitting the uplink data control information and a subframe pattern for transmitting the response information may be identical.

In addition, according to another example of this embodiment, in step S702, the base station may transmit response information to each user terminal separately, and alternatively, the base station may also transmit response information of a group of user terminals at the same time. The □group of user terminals□ herein may be the □user terminal group□ described above.

Then, in step S703, after transmitting the response information, the service information is received, where the service information includes data information. In this embodiment, the user terminal transmits the service information only after receiving the response information of the base station to the access information, thereby avoiding waste of radio resources. Accordingly, the base station receives the service information only after transmitting the response information.

According to one example of this embodiment, if the access information received by the base station in step S701 includes a preamble code and then the base station transmits response information of the base station to the preamble code in step S702, the base station may receive the data information in step S703.

According to another example of this embodiment, if the access information received by the base station in step S701 includes uplink data control information and then the base station transmits response information of the base station to the uplink data control information in step S702, the base station may receive the data information in step S703.

According to another example of this embodiment, if the access information received by the base station in step S701 includes a preamble code and uplink data control information and then the base station transmits response information of the base station to the preamble code and the uplink data control information in step S702, the base station may receive the data information in step S703.

According to another example of this embodiment, if the access information received by the base station in step S701 includes a preamble code and then the base station transmits response information of the base station to the preamble code in step S702, the base station may also receive uplink data control information and the data information in step S703.

According to another example of this embodiment, if the access information received by the base station in step S701 includes a preamble code and then the base station transmits response information of the base station to the preamble code in step S702, the base station may also receive uplink data control information firstly, transmit response information to the uplink data control information that includes acknowledgement information of the base station to the uplink data control information, and then receive service information after transmitting the response information of the uplink data control information in step S703.

The specific process of the base station receiving the service information in step S703 has been described above, and the time that the base station receives the service information in step S703 will be described below.

According to one example of this embodiment, the base station may also receive information indicating a second time interval when receiving the access information of the user terminal in step S701. After receiving the response information, the user terminal may transmit the service information to the base station after the second time interval, so that the base station receives the service information transmitted by the user terminal at a corresponding moment. For example, after receiving the response information, the user terminal may transmit the service information at a moment or any moment in a time window after a predetermined time interval.

As for the □first time interval□ and the □second time interval□ mentioned above, time lengths corresponding to them may be the same or different, which is not limited by this embodiment.

Steps S701-703 have been described in detail above, and examples of the method 700 may be further described with reference to FIGS. 2-6, which will not be repeatedly described herein.

According to the information transmission method for grant-free uplinks performed by a base station provided by the embodiments of the present disclosure, the user terminal firstly transmits the access information to the base station, and the user terminal transmits the service information only after receiving the base station acknowledgement information to the access information, thereby avoiding invalid transmission of the service information, and thus reducing waste of radio resources and improving uplink spectral efficiency.

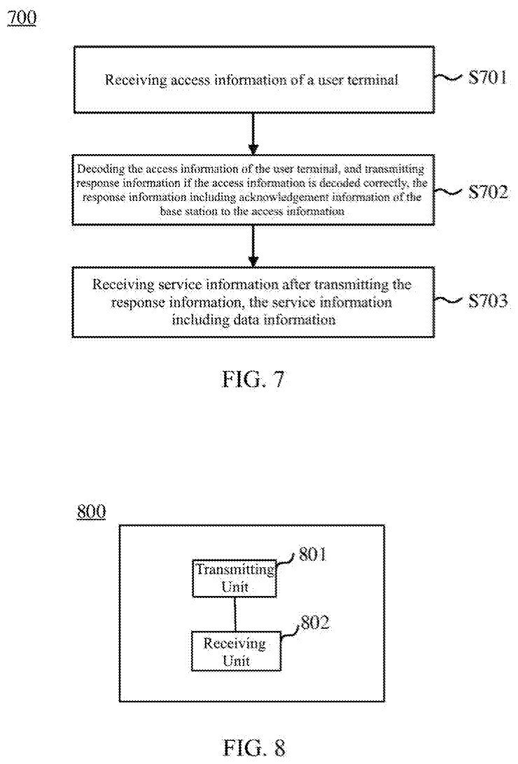

A user terminal performing the method 100 shown in FIG. 1 according to embodiments of the present disclosure will be described below with reference to FIG. 8. FIG. 8 shows a schematic structural diagram of the user terminal 800 performing the method 100 shown in FIG. 1.

As shown in FIG. 8, the user terminal 800 includes a transmitting unit 801 configured to transmit access information of the user terminal. The user terminal 800 further includes a receiving unit 802 configured to receive response information of a base station to the access information, where the response information includes acknowledgement information of the base station to the access information. Moreover, the transmitting unit 801 is further configured to transmit service information after the receiving unit 802 receives the response information to the access information, where the service information includes data information. The user terminal 800 may further include other components in addition to these three units. However, since these components are not related to the content of the embodiments of the present disclosure, illustration and description thereof are omitted herein. Furthermore, since specific details of the following operations performed by the user terminal 800 according to the embodiments of the present disclosure are the same as those described above with reference to FIGS. 2-6, repeated descriptions of the same details are omitted herein to avoid repetition.

According to one example of this embodiment, the access information may include a preamble code (also referred to as a preamble sequence or a random access preamble code) and/or uplink data control information.

For example, the preamble code may include a cyclic prefix CP with a length of Tcp and a sequence with a length of Tseq. For a cell formed by a base station, there may be 64 preamble codes. When accessing to the base station, the user terminal selects one of the 64 preamble codes for access to prevent access collisions with other user terminals.

Furthermore, the preamble code may further include identification information of the user terminal. The identification information of the user terminal may be, for example, the user terminal's ID, the user terminal's physical address (also referred to as Media Access Control (MAC) address), or other information that can uniquely identify the user terminal and the like, to identify the user terminal's identity. After receiving the preamble code of the user terminal, the base station may obtain the identification information of the user terminal from the preamble code, thereby identifying the user terminal's identity.

As another example, the uplink data control information may include Uplink Control CHannel (ULCCH) information of the user terminal.

As described above, the access information transmitted by the transmitting unit 801 may include both a preamble code and uplink data control information. Alternatively, the access information transmitted by the transmitting unit 801 may also include only one of a preamble code and uplink data control information.

When the access information includes a preamble code and uplink data control information, both the preamble code and the uplink data control information may include the identification information of the user terminal, or one of the two may include the identification information of the user terminal, to identify the user terminal's identity.

Furthermore, when the access information includes only uplink data control information, the uplink data control information may include the identification information of the user terminal. As described above, the identification information of the user terminal may be, for example, the user terminal's ID, the user terminal's MAC address, or other information that can uniquely identify the user terminal and the like, to identify the user terminal's identity. After receiving the uplink data control information of the user terminal, the base station may obtain the identification information of the user terminal from the uplink data control information, thereby identifying the user terminal's identity.

According to another example of this embodiment, the access information transmitted by the transmitting unit 801 may further include first scheduling information for the service information. The service information will be further described later.

According to an example of this embodiment, the first scheduling information may include at least one of modulation and coding information for the service information, information on the number of times of retransmissions for the service information, transmission power control information for the service information, signature information for the service information, reference signal information for the service information, and radio resource information for the service information. After receiving the first scheduling information, the base station may process the service information transmitted by the user terminal according to the first scheduling information.

For example, the modulation and coding information for the service information may indicate a modulation and coding mode adopted by the user terminal when transmitting the service information, so that the base station may demodulate and decode the service information according to the modulation and coding information after receiving the service information.

As another example, the information on the number of times of retransmissions for the service information may indicate the number of times of retransmissions after the user terminal failing to transmit the service information, so that the base station may perform hybrid feedback retransmission combination on the service information received for multiple times.

As yet another example, the transmission power control information for the service information may indicate a transmission power adopted by the user terminal when transmitting the service information, so that the base station may obtain the transmission power for the user terminal, and thereby perform channel measurement or channel estimation.

As yet another example, the signature information for the service information may indicate an interleaving mode adopted by the user terminal when transmitting the service information, so that the base station may recover information before interleaving according to the interleaving mode after receiving the service information (this operation may also be referred to as □de-interleaving□). The signature information for the service information may also indicate a scrambling mode adopted by the user terminal when transmitting the service information, so that the base station may recover information before scrambling according to the scrambling mode after receiving the service information (this operation may also be referred to as □de-scrambling□). The signature information for the service information may also indicate a spreading mode adopted by the user terminal when transmitting the service information, so that the base station may recover information before spreading according to the spreading mode after receiving the service information. Certainly, the signature information for the service information is not limited to the interleaving mode, the scrambling mode, and the spreading mode listed herein, and may also indicate other operations that the user terminal performs on the service information when transmitting the service information.

As yet another example, the reference signal information for the service information may indicate reference signals of a channel adopted by the user terminal when transmitting the service information, so that the base station may perform channel measurement or channel estimation.

As yet another example, the radio resource information for the service information may indicate radio resources occupied by the user terminal when transmitting the service information, so that the base station may receive the service information on the radio resources.

Then, the receiving unit 802 receives the response information of the base station to the access information, where the response information includes acknowledgement information (also referred to as □ACK□) of the base station to the access information. In this embodiment, when the base station decodes the access information correctly, the base station may feed back the acknowledgement information to the user terminal. On the other hand, when the base station does not decode the access information correctly, the base station may not feed back any information to the user terminal, or may feed back non-acknowledgment information (also referred to as □NACK□) to the user terminal.

According to one example of this embodiment, when the access information transmitted by the transmitting unit 801 includes a preamble code, the receiving unit 802 receives response information of the base station to the preamble code, where the response information includes acknowledgement information of the base station to the preamble code. For example, when the transmitting unit 801 transmits the preamble code, the base station receives and decodes the preamble code. If the decoding is performed correctly, the base station may feed back the acknowledgement information to the user terminal, and the receiving unit 802 receives the acknowledgement information of the base station to the preamble code. In this example, a correct decoding may be that the base station obtains the identification information of the user terminal through the decoding and thereby identifies the user terminal's identity.

According to another example of this embodiment, when the access information transmitted by the transmitting unit 801 includes uplink data control information, the receiving unit 802 receives response information of the base station to the uplink data control information, where the response information includes acknowledgement information of the base station to the uplink data control information. For example, when the transmitting unit 801 transmits the uplink data control information, the base station receives and decodes the uplink data control information. If the decoding is performed correctly, the base station may feed back acknowledgement information to the user terminal, and the receiving unit 802 receives the acknowledgement information of the base station to the uplink data control information.

According to another example of this embodiment, when the access information transmitted by transmitting unit 801 includes a preamble code and uplink data control information, the receiving unit 802 receives response information of the base station to the preamble code and the uplink data control information, where the response information includes acknowledgement information of the base station to the preamble code and the uplink data control information. For example, when the transmitting unit 801 transmits the preamble code and the uplink data control information, the base station receives and decodes the preamble code and the uplink data control information. If the decoding is performed correctly, the base station may feed back acknowledgement information to the user terminal, and the receiving unit 802 receives the acknowledgement information of the base station to the preamble code and the uplink data control information.

In this example, the base station feeds back the acknowledgement information to the user terminal only after correctly decoding the preamble code and the uplink data control information, respectively.

In addition, according to another example of this embodiment, the response information received by the receiving unit 802 may further include Timing Advance (TA) information transmitted by the base station to the user terminal. For example, the base station may transmit a timing advance command to the user terminal to inform the user terminal of the amount of time of the timing advance, thereby avoiding transmission delay caused by the distance between the base station and the user terminal, and reducing interference between the user terminal and other user terminals.

Furthermore, according to another example of this embodiment, when the transmitting unit 801 transmits the first scheduling information for the service information, the base station receives the first scheduling information for the service information. Then, the base station generates modified scheduling information according to the first scheduling information for the service information, and feeds back the modified scheduling information to the user terminal by including it in the response information. Accordingly, the receiving unit 802 receives the modified scheduling information.

For example, when the transmitting unit 801 transmits scheduling information for the service information, the base station receives the scheduling information for the service information. Then, the base station may flexibly modify the received scheduling information based on load conditions, channel conditions and the like in the cell to obtain the modified scheduling information. The base station may then feed back the modified scheduling information to the user terminal by including it in the response information. Accordingly, the receiving unit 802 receives the modified scheduling information. Then, the transmitting unit 801 transmits the service information to the base station based on the modified scheduling information.

For example, the scheduling information transmitted by the transmitting unit 801 may include the modulation and coding information for the service information. When the transmitting unit 801 transmits the modulation and coding information for the service information, the base station receives the modulation and coding information for the service information. Then, the base station may select a preferable coding and modulation mode for the user terminal based on load conditions, channel conditions and the like in the cell, to obtain information on the preferable modulation and coding mode. Then, the base station may feed back the information on the preferable modulation and coding mode to the user terminal by including it in the response information. Accordingly, the receiving unit 802 receives the information on the preferable modulation and coding mode. Then, the transmitting unit 801 transmits the service information to the base station based on the preferable modulation and coding mode.

Similarly, the scheduling information transmitted by the transmitting unit 801 may include information on the number of times of retransmissions for the service information, transmission power control information for the service information, signature information for the service information, reference signal information for the service information, or radio resource information for the service information and the like. That is, the base station may select the number of times of retransmissions, a transmission power, a signature mode, radio resources and the like that are preferable for the user terminal based on load conditions, channel conditions and the like in the cell.

Certainly, the base station may also select a modulation and coding mode, the number of times of retransmissions, a transmission power, a signature mode, radio resources and the like that are inferior for the user terminal based on load conditions, channel conditions and the like in the cell, which sacrifices part of the user terminal performance while realizes an overall performance improvement of the cell.

According to another example of this embodiment, the base station may further transmit second scheduling information to the user terminal. For example, when the transmitting unit 801 transmits the first scheduling information for the service information, the response information received by the receiving unit 802 may further include the second scheduling information. Specifically, the second scheduling information may be supplementary information of the base station to the first scheduling information.

For example, when the transmitting unit 801 transmits only the modulation and coding information in the scheduling information for the service information, the response information received by the receiving unit 802 may include other information in the scheduling information for the service information, such as information on the number of times of retransmissions, transmission power control information for the service information, signature information for the service information, reference signal information for the service information, radio resource information for the service information, and the like.

According to another example of this embodiment, when the transmitting unit 801 transmits the first scheduling information for the service information, the response information received by the receiving unit 802 may include not only the modified first scheduling information, but also the second scheduling information.

For example, when the transmitting unit 801 transmits only the modulation and coding information in the scheduling information for the service information, the base station modifies the modulation and coding information after receiving it to obtain modified modulation and coding information, and thus the response information received by the receiving unit 802 may include not only other information in the scheduling information for the service information, such as information on the number of times of retransmissions, transmission power control information for the service information, signature information for the service information, reference signal information for the service information, radio resource information for the service information and the like, but also the modified modulation and coding information.

The specific content of the response information received by the receiving unit 802 has been described above, and the time that the receiving unit 802 receives the response information will be described below. In this embodiment, the time that the receiving unit 802 receives the response information may be a moment or a time window.

According to an example of this embodiment, the transmitting unit 801 may transmit information indicating a first time interval to the base station when transmitting the access information of the user terminal. The base station may transmit the response information to the access information after the first time interval according to the received access information. For example, after receiving the access information, the base station may transmit the response information of the base station to the access information at a moment or any moment in a time window after a predetermined time interval. Accordingly, the receiving unit 802 may receive the response information of the base station to the access information at a moment or in a time window after the first time interval.

According to another example of this embodiment, the transmitting unit 801 may also determine a periodic information-receiving window, and receive the response information of the base station to the access information in a first information-receiving window after transmitting the access information of the user terminal. The information-receiving window may be a time window for transmitting signaling between the user terminal and the base station. Alternatively, the information-receiving window may be a time period.

In this example, the signaling transmitted in the time window may include user terminal-specific signaling information transmitted by the base station to the user terminal, or group-specific signaling information of a user terminal group to which the user terminal belongs. The user terminal-specific signaling may include cell reference signals, downlink control information and the like; the group-specific signaling information may include channel quality conditions, resource allocation conditions, user terminal grouping conditions, and so on.

The user terminal group mentioned herein may include one or more user terminals transmitting signaling information in a same time slot, or may include one or more user terminals transmitting signaling information in a same frequency band, or may be one or more user terminals that transmit access information within a time period between two adjacent information-receiving windows.

Furthermore, according to another example of this embodiment, the base station may transmit the response information to the access information on an existing downlink channel, or may transmit the response information to the access information on a dedicated channel.

Specifically, the base station may transmit the response information to the access information on a downlink control channel, a downlink data channel, or a response information transmission channel. Accordingly, the receiving unit 802 receives the response information of the base station to the access information on the corresponding downlink control channel, the downlink data channel, or the response information transmission channel.

For example, the downlink control channel may include a Physical Downlink Control Channel (PDCCH), a Physical Multicast Channel (PMCH), a Physical Broadcast Channel (PBCH), a Physical Control Format Indicator Channel (PCFICH), and a Physical HARQ Indicator Channel (PHICH) and the like; the downlink data channel may include a Physical Downlink Shared Channel (PDSCH) and the like; the response information transmission channel may include a channel dedicated to receive the response information.

According to another example of this embodiment, the receiving unit 802 may determine radio resources carrying the response information based on at least one of the identification information of the user terminal and information on radio resources for transmitting the uplink data control information, and then receive the response information of the base station to the access information on the radio resources.

For example, the base station determines, for user terminals in the cell, a radio resource pool for transmitting response information. After receiving access information of a certain user terminal, the base station selects radio resources for the user terminal, and then transmits response information to the access information of this user terminal on the radio resources. The receiving unit 802 may deduce index numbers of radio resources used by the base station based on the identification information of the user terminal, and then receive the response information on the radio resources corresponding to the index numbers.

As another example, the base station determines, for user terminals in the cell, a radio resource pool for transmitting response information. After receiving access information of a user terminal, the base station selects radio resources for the user terminal, and then transmits response information to the access information of this user terminal on the radio resources. The receiving unit 802 may deduce index numbers of radio resources used by the base station not only based on the identification information of the user terminal but also based on the information on radio resources for transmitting the uplink data control information, and then receive the response information on the radio resources corresponding to the index numbers.

In this example, the base station may use frequency resources for transmitting the uplink data control information as frequency resources for transmitting the response information. That is, frequency resources for transmitting the uplink data control information and frequency resources for transmitting the response information may be identical. Alternatively, the base station may also use a subframe pattern corresponding to radio resources for transmitting the uplink data control information as a subframe pattern for transmitting the response information. That is, a subframe pattern for transmitting the uplink data control information and a subframe pattern for transmitting the response information may be identical.

Then, after the receiving unit 802 receives the response information to the access information, the transmitting unit 801 transmits the service information, where the service information includes data information. In this embodiment, the transmitting unit 801 transmits the service information only after the receiving unit 802 receives the response information of the base station to the access information, thereby avoiding waste of radio resources.

According to one example of this embodiment, if the access information transmitted by the transmitting unit 801 includes a preamble code and then the receiving unit 802 receives response information of the base station to the preamble code, the transmitting unit 801 transmits the data information.

According to another example of this embodiment, if the access information transmitted by the transmitting unit 801 includes uplink data control information and then the receiving unit 802 receives response information of the base station to the uplink data control information, the transmitting unit 801 transmits the data information.

According to another example of this embodiment, if the access information transmitted by the transmitting unit 801 includes a preamble code and uplink data control information and then the receiving unit 802 receives response information of the base station to the preamble code and the uplink data control information, the transmitting unit 801 transmits the data information.

According to another example of this embodiment, if the access information transmitted by the transmitting unit 801 includes a preamble code and then the receiving unit 802 receives response information of the base station to the preamble code, the transmitting unit 801 transmits uplink data control information and the data information.

According to another example of this embodiment, if the access information transmitted by the transmitting unit 801 includes a preamble code and then the receiving unit 802 receives response information of the base station to the preamble code, the transmitting unit 801 transmits uplink data control information firstly, receives response information of the base station to the uplink data control information that includes acknowledgement information of the base station to the uplink data control information, and then transmits service information after receiving the response information of the uplink data control information.

The specific process of the transmitting unit 801 transmitting the service information has been described above, and the time that the transmitting unit 801 transmits the service information will be described below.

According to one example of this embodiment, the transmitting unit 801 may also transmit information indicating a second time interval to the base station when transmitting the access information of the user terminal. After receiving the response information, the user terminal may transmit the service information to the base station after the second time interval, so that the base station receives the service information transmitted by the user terminal at a corresponding moment. For example, after receiving the response information, the user terminal may transmit the service information at a moment or any moment in a time window after a predetermined time interval.

According to another example of this embodiment, the transmitting unit 801 may not transmit information indicating the second time interval to the base station. Specifically, after receiving the response information, the user terminal may transmit the service information after a third time interval.

As for the □first time interval□, the □second time interval□ and the □third time interval□ mentioned above, time lengths corresponding to them may be the same or different, which is not limited by this embodiment.

The user terminal 800 has been described in detail above, and examples of the user terminal 800 may be further described with reference to FIGS. 2-6, which is not repeatedly described herein.

According to the user terminal for information transmission in grant-free uplinks provided by the embodiments of the present disclosure, the user terminal firstly transmits the access information to the base station, and the user terminal transmits the service information only after receiving the base stations [symbol] acknowledgement information to the access information, thereby avoiding invalid transmission of the service information, and thus reducing waste of radio resources and improving uplink spectral efficiency.

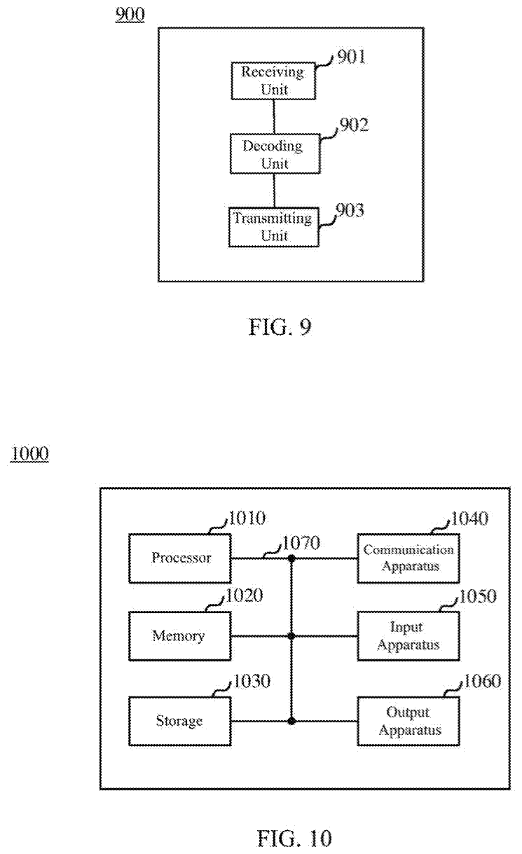

A base station performing the method 700 shown in FIG. 7 according to embodiments of the present disclosure will be described below with reference to FIG. 9. FIG. 9 shows a schematic structural diagram of the base station 900 performing the method 700 shown in FIG. 7.

As shown in FIG. 9, the base station 900 includes a receiving unit 901 configured to receive access information of a user terminal. The base station 900 further includes a decoding unit 902 configured to decode the access information of the user terminal. The base station 900 further includes a transmitting unit 903 which is configured to transmit the response information after the decoding unit 902 correctly decodes the access information of the user terminal, where the response information includes acknowledgement information of the base station to the access information. In addition, the receiving unit 901 is further configured to receive service information after the transmitting unit 903 transmits the response information, where the service information includes data information. The base station 900 may further include other components in addition to these three units. However, since these components are not related to the content of the embodiments of the present disclosure, illustration and description thereof are omitted herein. Furthermore, since specific details of the following operations performed by the base station 900 according to the embodiments of the present disclosure are the same as those described above with reference to FIGS. 2-6, repeated descriptions of the same details are omitted herein to avoid repetition.

According to one example of this embodiment, the access information may include a preamble code (also referred to as a preamble sequence or a random access preamble code) and/or uplink data control information.

For example, the preamble code may include a cyclic prefix CP with a length of Tcp and a sequence with a length of Tseq. For a cell formed by a base station, there may be 64 preamble codes. When accessing to the base station, the user terminal selects one of the 64 preamble codes for access to prevent access collisions with other user terminals.

Furthermore, the preamble code may further include identification information of the user terminal. The identification information of the user terminal may be, for example, the user terminal's ID, the user terminal's physical address (also referred to as Media Access Control (MAC) address), or other information that can uniquely identify the user terminal and the like, to identify the user terminal's identity. After receiving the preamble code of the user terminal, the base station may obtain the identification information of the user terminal from the preamble code, thereby identifying the user terminal's identity.

As another example, the uplink data control information may include Uplink Control CHannel (ULCCH) information of the user terminal.

As described above, the access information received by the receiving unit 901 may include both a preamble code and uplink data control information. Alternatively, the access information received by the receiving unit 901 may also include only one of a preamble code and uplink data control information.

When the access information includes a preamble code and uplink data control information, both the preamble code and the uplink data control information may include the identification information of the user terminal, or one of the two may include the identification information of the user terminal, to identify the user terminal's identity.

Furthermore, when the access information includes only uplink data control information, the uplink data control information may include the identification information of the user terminal. As described above, the identification information of the user terminal may be, for example, the user terminal's ID, the user terminal's MAC address, or other information that can uniquely identify the user terminal and the like, to identify the user terminal's identity. After receiving the uplink data control information of the user terminal, the base station may obtain the identification information of the user terminal from the uplink data control information, thereby identifying the user terminal's identity.

According to another example of this embodiment, the access information received by the receiving unit 901 may further include first scheduling information for the service information. The service information will be further described later.

According to an example of this embodiment, the first scheduling information may include at least one of modulation and coding information for the service information, information on the number of times of retransmissions for the service information, transmission power control information for the service information, signature information for the service information, reference signal information for the service information, and radio resource information for the service information. After receiving the first scheduling information, the base station may process the service information transmitted by the user terminal according to the first scheduling information.

For example, the modulation and coding information for the service information may indicate a modulation and coding mode adopted by the user terminal when transmitting the service information, so that the base station may demodulate and decode the service information according to the modulation and coding information after receiving the service information.

As another example, the information on the number of times of retransmissions for the service information may indicate the number of times of retransmissions after the user terminal failing to transmit the service information, so that the base station may perform hybrid feedback retransmission combination on the service information received for multiple times.

As yet another example, the transmission power control information for the service information may indicate a transmission power adopted by the user terminal when transmitting the service information, so that the base station may obtain the transmission power for the user terminal, and thereby perform channel measurement or channel estimation.

As yet another example, the signature information for the service information may indicate an interleaving mode adopted by the user terminal when transmitting the service information, so that the base station may recover information before interleaving according to the interleaving mode after receiving the service information (this operation may also be referred to as □de-interleaving□). The signature information for the service information may also indicate a scrambling mode adopted by the user terminal when transmitting the service information, so that the base station may recover information before scrambling according to the scrambling mode after receiving the service information (this operation may also be referred to as □de-scrambling□). The signature information for the service information may also indicate a spreading mode adopted by the user terminal when transmitting the service information, so that the base station may recover information before spreading according to the spreading mode after receiving the service information. Certainly, the signature information for the service information is not limited to the interleaving mode, the scrambling mode, and the spreading mode listed herein, and may also indicate other operations that the user terminal performs on the service information when transmitting the service information.

As yet another example, the reference signal information for the service information may indicate reference signals of a channel adopted by the user terminal when transmitting the service information, so that the base station may perform channel measurement or channel estimation.

As yet another example, the radio resource information for the service information may indicate radio resources occupied by the user terminal when transmitting the service information, so that the base station may receive the service information on the radio resources.

Then, the decoding unit 902 decodes the access information of the user terminal, and transmits response information if decoding correctly, where the response information includes acknowledgement information (also referred to as □ACK□) of the base station to the access information. In this embodiment, when the base station decodes the access information correctly, the base station may feed back the acknowledgement information to the user terminal. On the other hand, when the base station does not decode the access information correctly, the base station may not feed back any information to the user terminal, or may feed back non-acknowledgment information (also referred to as □NACK□) to the user terminal.

According to one example of this embodiment, when the access information received by the receiving unit 901 includes a preamble code, the decoding unit 902 decodes the preamble code of the user terminal, and if decoding correctly, the transmitting unit 903 transmits response information, where the response information includes acknowledgement information of the base station to the preamble code. For example, after the receiving unit 901 receives the preamble code, the decoding unit 902 decodes the preamble code, and if decoding correctly, the acknowledgement information may be fed back to the user terminal. In this example, a correct decoding may be that the base station obtains the identification information of the user terminal through the decoding and thereby identifies the user terminal's identity.

According to another example of this embodiment, when the access information received by the receiving unit 901 includes uplink data control information, the decoding unit 902 decodes the uplink data control information of the user terminal, and if decoding correctly, the transmitting unit 903 transmits response information, where the response information includes acknowledgement information of the base station to the uplink data control information. For example, after the receiving unit 901 receives the uplink data control information, the decoding unit 902 decodes the uplink data control information, and if decoding correctly, the transmitting unit 903 may feed back acknowledgement information to the user terminal.

According to another example of this embodiment, when the access information received by the receiving unit 901 includes a preamble code and uplink data control information, the decoding unit 902 decodes the preamble code and the uplink data control information of the user terminal, and if decoding correctly, the transmitting unit 903 transmits response information, where the response information includes acknowledgement information of the base station to the preamble code and the uplink data control information. For example, after the receiving unit 901 receives the preamble code and the uplink data control information, the decoding unit 902 decodes them, and if decoding correctly, the transmitting unit 903 may feed back acknowledgement information to the user terminal.

In this example, the acknowledgement information is fed back to the user terminal only after the decoding unit 902 correctly decodes the preamble code and the uplink data control information, respectively.

In addition, according to another example of this embodiment, the response information transmitted by the transmitting unit 903 may further include Timing Advance (TA) information transmitted by the base station to the user terminal. For example, the base station may transmit a timing advance command to the user terminal to inform the user terminal of the amount of time of the timing advance, thereby avoiding transmission delay caused by the distance between the base station and the user terminal, and reducing interference between the user terminal and other user terminals.

Furthermore, according to another example of this embodiment, when the receiving unit 901 receives the first scheduling information for the service information, the base station generates modified scheduling information according to the first scheduling information for the service information, and the transmitting unit 903 feeds back the modified scheduling information to the user terminal by including it in the response information.

For example, when the user terminal transmits scheduling information for the service information, the base station receives the scheduling information for the service information. Then, the base station may flexibly modify the received scheduling information based on load conditions, channel conditions and the like in the cell to obtain the modified scheduling information. The base station may then feed back the modified scheduling information to the user terminal by including it in the response information. Accordingly, the user terminal receives the modified scheduling information. Then, the user terminal may transmit the service information to the base station based on the modified scheduling information.

For example, the scheduling information received by the receiving unit 901 may include the modulation and coding information for the service information, and then the base station may select a preferable coding and modulation mode for the user terminal based on load conditions, channel conditions and the like in the cell, to obtain information on the preferable modulation and coding mode. Then, the transmitting unit 903 may feed back the information on the preferable modulation and coding mode to the user terminal by including it in the response information. After receiving the information on the preferable modulation and coding mode, the user terminal may transmit the service information to the base station based on the preferable modulation and coding mode.

Similarly, the scheduling information received by the receiving unit 901 may include information on the number of times of retransmissions for the service information, transmission power control information for the service information, signature information for the service information, reference signal information for the service information, or radio resource information for the service information and the like. That is, the base station may select the number of times of retransmissions, a transmission power, a signature mode, radio resources and the like that are preferable for the user terminal based on load conditions, channel conditions and the like in the cell.

Certainly, the base station may also select a modulation and coding mode, the number of times of retransmissions, a transmission power, a signature mode, radio resources and the like that are inferior for the user terminal based on load conditions, channel conditions and the like in the cell, which sacrifices part of the user terminal performance while realizes an overall performance improvement of the cell.

According to another example of this embodiment, the transmitting unit 903 may further transmit second scheduling information to the user terminal. For example, when the receiving unit 901 receives the first scheduling information for the service information, the base station may generate the second scheduling information, and the response information transmitted by the transmitting unit 903 may further include the second scheduling information. Specifically, the second scheduling information may be supplementary information of the base station to the first scheduling information.

For example, when the receiving unit 901 receives only the modulation and coding information in the scheduling information for the service information, the response information transmitted by the transmitting unit 903 may include other information in the scheduling information for the service information, such as information on the number of times of retransmissions, transmission power control information for the service information, signature information for the service information, reference signal information for the service information, radio resource information for the service information, and the like.

According to another example of this embodiment, when the receiving unit 901 receives the first scheduling information for the service information, the response information transmitted by the transmitting unit 903 may include not only the modified first scheduling information, but also the second scheduling information.

For example, when the receiving unit 901 receives only the modulation and coding information in the scheduling information for the service information, the base station modifies the modulation and coding information after receiving it to obtain modified modulation and coding information, and thus the response information transmitted by the transmitting unit 903 may include not only other information in the scheduling information for the service information, such as information on the number of times of retransmissions, transmission power control information for the service information, signature information for the service information, reference signal information for the service information, radio resource information for the service information and the like, but also the modified modulation and coding information.

The specific content of the response information transmitted by the transmitting unit 903 has been described above, and the time that the transmitting unit 903 transmits the response information will be described below. In this embodiment, the time that the transmitting unit 903 transmits the response information may be a moment or a time window.

According to an example of this embodiment, the receiving unit 901 may further receive information indicating a first time interval. After receiving the access information, the base station may transmit the response information to the access information after the first time interval. For example, after receiving the access information, the base station may transmit the response information of the base station to the access information at a moment or any moment in a time window after a predetermined time interval. Accordingly, the user terminal may receive the response information of the base station to the access information at a moment or in a time window after the first time interval.

According to another example of this embodiment, the base station may also determine a periodic information-receiving window, and transmit the response information of the base station to the access information in a first information-receiving window after the receiving unit 901 receives the access information of the user terminal. The information-receiving window may be a time window for transmitting signaling between the user terminal and the base station. Alternatively, the information-receiving window may be a time period.

In this example, the signaling transmitted in the time window may include user terminal-specific signaling information transmitted by the base station to the user terminal, or group-specific signaling information of a user terminal group to which the user terminal belongs. The user terminal-specific signaling may include cell reference signals, downlink control information and the like; the group-specific signaling information may include channel quality conditions, resource allocation conditions, user terminal grouping conditions, and so on.

The user terminal group mentioned herein may include one or more user terminals transmitting signaling information in a same time slot, or may include one or more user terminals transmitting signaling information in a same frequency band, or may be one or more user terminals that transmit access information within a time period between two adjacent information-receiving windows.

Furthermore, according to another example of this embodiment, the base station may transmit the response information to the access information on an existing downlink channel, or may transmit the response information to the access information on a dedicated channel.

Specifically, the transmitting unit 903 may transmit the response information to the access information on a downlink control channel, a downlink data channel, or a response information transmission channel. Accordingly, the user terminal receives the response information of the base station to the access information on the corresponding downlink control channel, the downlink data channel, or the response information transmission channel.

For example, the downlink control channel may include a Physical Downlink Control Channel (PDCCH), a Physical Multicast Channel (PMCH), a Physical Broadcast Channel (PBCH), a Physical Control Format Indicator Channel (PCFICH), and a Physical HARQ Indicator Channel (PHICH) and the like; the downlink data channel may include a Physical Downlink Shared Channel (PDSCH) and the like; the response information transmission channel may include a channel dedicated to receive the response information.

According to another example of this embodiment, the transmitting unit 903 may determine radio resources carrying the response information based on at least one of the identification information of the user terminal and information on radio resources for transmitting the uplink data control information, and then transmit the response information of the base station to the access information on the radio resources.

For example, the base station determines, for user terminals in the cell, a radio resource pool for transmitting response information. After receiving access information of a user terminal, the base station selects radio resources for the user terminal, and then transmits response information to the access information of this user terminal on the radio resources. The transmitting unit 903 may deduce index numbers of radio resources used by the base station based on the identification information of the user terminal, and then transmit the response information on the radio resources corresponding to the index numbers.

As another example, the base station determines, for user terminals in the cell, a radio resource pool for transmitting response information. After receiving access information of a user terminal, the base station selects radio resources for the user terminal, and then transmits response information to the access information of this user terminal on the radio resources. The transmitting unit 903 may deduce index numbers of radio resources used by the base station not only based on the identification information of the user terminal but also based on the information on radio resources for transmitting the uplink data control information, and then transmit the response information on the radio resources corresponding to the index numbers.

In this example, the base station may use frequency resources for transmitting the uplink data control information as frequency resources for transmitting the response information. That is, frequency resources for transmitting the uplink data control information and frequency resources for transmitting the response information may be identical. Alternatively, the base station may also use a pattern corresponding to radio resources for transmitting the uplink data control information as a subframe pattern for transmitting the response information. That is, a subframe pattern for transmitting the uplink data control information and a subframe pattern for transmitting the response information may be identical.

In addition, according to another example of this embodiment, the transmitting unit 903 may transmit response information to each user terminal separately, and alternatively, the base station may also transmit response information of a group of user terminals at the same time. The □group of user terminals□ herein may be the □user terminal group□ described above.

Then, after the transmitting unit 903 transmits the response information, the receiving unit 901 receives service information, where the service information includes data information. In this embodiment, the user terminal transmits the service information only after receiving the response information of the base station to the access information, thereby avoiding waste of radio resources. Accordingly, the receiving unit 901 receives the service information only after the transmitting unit 903 transmits the response information.

According to an example of this embodiment, if the access information received by the receiving unit 901 includes a preamble code and then the transmitting unit 903 transmits response information of the base station to the preamble code, the receiving unit 901 may receive the data information.

According to another example of this embodiment, if the access information received by the receiving unit 901 includes uplink data control information and then the transmitting unit 903 transmits response information of the base station to the uplink data control information in step S702, the receiving unit 901 may receive the data information.

According to another example of this embodiment, if the access information received by the receiving unit 901 includes a preamble code and uplink data control information and then the transmitting unit 903 transmits response information of the base station to the preamble code and the uplink data control information, the receiving unit 901 may receive the data information.

According to another example of this embodiment, if the access information received by the receiving unit 901 includes a preamble code and then the transmitting unit 903 transmits response information of the base station to the preamble code, the receiving unit 901 may also receive uplink data control information and the data information.

According to another example of this embodiment, if the access information received by the receiving unit 901 includes a preamble code and then the transmitting unit 903 transmits response information of the base station to the preamble code, the receiving unit 901 may also receive uplink data control information firstly, transmit response information to the uplink data control information that includes acknowledgement information of the base station to the uplink data control information, and then receive service information after the transmitting unit 903 transmits the response information of the uplink data control information.

In addition, according to an example of this embodiment, the receiving unit 901 may also receive information indicating a second time interval when receiving the access information of the user terminal. After receiving the response information, the user terminal may transmit the service information to the base station after the second time interval, so that the base station receives the service information transmitted by the user terminal at a corresponding moment. For example, after receiving the response information, the user terminal may transmit the service information at a moment or any moment in a time window after a predetermined time interval.

As for the □first time interval□ and the □second time interval□ mentioned above, time lengths corresponding to them may be the same or different, which is not limited by this embodiment.

The base station 900 has been described in detail above, and examples of the base station 900 may be further described with reference to FIGS. 2-6, which will not be repeatedly described herein.

According to the base station for information transmission of grant-free uplinks provided by the embodiments of the present disclosure, the user terminal first transmits the access information to the base station, and the user terminal transmits the service information only after receiving the base station acknowledgement information to the access information, thereby avoiding invalid transmission of the service information, and thus reducing waste of radio resources and improving uplink spectral efficiency.

In addition, block diagrams used in the description of the above embodiments illustrate blocks in units. These structural blocks may be implemented in arbitrary combination of hardware and/or software. Furthermore, means for implementing respective structural blocks is not particularly limited. That is, the respective structural blocks may be implemented by one apparatus that is physically and/or logically jointed; or more than two apparatuses that are physically and/or logically separated may be directly and/or indirectly connected (e.g., in a wire and/or wireless mode), and the respective structural blocks may be implemented by these apparatuses.

For example, the user equipment in the embodiments of the present disclosure may function as a computer that executes the processes of the information transmission method of the present disclosure. FIG. 10 shows a schematic diagram of hardware structure of a user equipment 1000 related according to an embodiment of the present disclosure. The above user equipment 1000 may be constituted as a computer apparatus that physically comprises a processor 1010, a memory 1020, a storage 1030, a communication apparatus 1040, an input apparatus 1050, an output apparatus 1060, a bus 1070 and the like

In addition, in the following description, terms such as □apparatus□ may be replaced with circuits, devices, units, and the like. The hardware structure of the user equipment 1000 may include one or more of the respective apparatuses shown in the figure, or may not include a part of the apparatuses.

For example, only one processor 1010 is illustrated, but there may be multiple processors. Furthermore, processes may be performed by one processor, or processes may be performed by more than one processor simultaneously, sequentially, or by other methods. In addition, the processor 1010 may be installed by more than one chip.

Respective functions of the user equipment 1000 may be implemented, for example, by reading specified software (program) on hardware such as the processor 1010 and the memory 1020, so that the processor 1010 performs computations, controls communication performed by the communication apparatus 1040, and controls reading and/or writing of data in the memory 1020 and the storage 1030.

The processor 1010, for example, operates an operating system to control the entire computer. The processor 1010 may be constituted by a Central Processing Unit (CPU), which includes interfaces with peripheral apparatuses, a control apparatus, a computing apparatus, a register and the like. For example, the baseband signal processing unit, the call processing unit and the like described above may be implemented by the processor 1010.

In addition, the processor 1010 reads programs (program codes), software modules and data from the storage 1030 and/or the communication apparatus 1040 to the memory 1020, and execute various processes according to them. As for the program, a program causing computers to execute at least a part of the operations described in the above embodiments may be employed. For example, a control unit of the user equipment 1000 may be implemented by a control program stored in the memory 1020 and operated by the processor 1010, and other functional blocks may also be implemented similarly.

The memory 1020 is a computer-readable recording medium, and may be constituted, for example, by at least one of a Read Only Memory (ROM), an Erasable Programmable ROM (EPROM), an Electrically EPROM (EEPROM), a Random Access Memory (RAM) and other appropriate storage media. The memory 1020 may also be referred to as a register, a cache, a main memory (a main storage apparatus) and the like. The memory 1020 may store executable programs (program codes), software modules or the like for implementing wireless communication methods related to an embodiment of the present disclosure.

The storage 1030 is a computer-readable recording medium, and may be constituted, for example, by at least one of a flexible disk, a Floppy® disk, a magneto-optical disk (e.g., a Compact Disc ROM (CD-ROM) and the like), a digital versatile disk, a Blu-ray® disk, a removable disk, a hard driver, a smart card, a flash memory device (e.g., a card, a stick and a key driver), a magnetic stripe, a database, a server, and other appropriate storage media. The storage 1030 may also be referred to as an auxiliary storage apparatus.

The communication apparatus 1040 is a hardware (transceiver device) performing communication between computers via a wired and/or wireless network, and is also referred to as a network device, a network controller, a network card, a communication module or the like, for example. The communication device 1040 may include a high-frequency switch, a duplexer, a filter, a frequency synthesizer and the like to implement, for example, Frequency Division Duplex (FDD) and/or Time Division Duplex (TDD). For example, the transmitting and receiving antennas, amplifying unit, transmitting and receiving units, transmission path interfaces and the like described above may be implemented by the communication apparatus 1040.

The input apparatus 1050 is an input device (e.g., a keyboard, a mouse, a microphone, a switch, a button, a sensor and the like) that receives input from the outside. The output apparatus 1060 is an output device (e.g., a display, a speaker, a Light Emitting Diode (LED) light and the like) that performs outputting to the outside. In addition, the input apparatus 1050 and the output apparatus 1060 may also be an integrated structure (e.g., a touch screen).

Furthermore, the respective apparatuses such as the processor 1010 and the memory 1020 are connected by the bus 1070 that communicates information. The bus 1070 may be constituted by a single bus or by different buses between the apparatuses.

Furthermore, the user equipment 1000 may comprise hardware such as a microprocessor, a Digital Signal Processor (DSP), an Application Specified Integrated Circuit (ASIC), a Programmable Logic Device (PLD), a Field Programmable Gate Array (FPGA), etc., and the hardware may be used to implement a part of or all of the respective functional blocks. For example, the processor 1010 may be installed by at least one of the hardware.

The terms illustrated in the present specification and/or the terms required for understanding of the present specification may be substituted with terms having the same or similar meaning. For example, a channel and/or a symbol may also be a signal (signaling). Furthermore, the signal may be a message. A reference signal may be abbreviated as an CRS and may also be referred to as a □pilot□, a □pilot signal□ and so on, depending on the standard applied. Furthermore, a component carrier (CC) may also be referred to as a cell, a frequency carrier, a carrier frequency, and the like.

In addition, a radio frame may be composed of one or more periods (frames) in the time domain. Each of the one or more periods (frames) constituting the radio frame may also be referred to as a subframe. Further, a subframe may be composed of one or more slots in the time domain. The subframe may be a fixed length of time duration (e.g., 1 ms) that is independent of the numerology.

Furthermore, a slot may be composed of one or more symbols (OFDM (Orthogonal Frequency Division Multiplexing) symbols, SC-FDMA (Single Carrier Frequency Division Multiple Access) symbols, etc.) in the time domain. Furthermore, the slot may also be a time unit based on the numerology. Furthermore, the slot may also include a plurality of microslots. Each microslot may be composed of one or more symbols in the time domain. Furthermore, a microslot may also be referred to as a □subframe□.

A radio frame, a subframe, a slot, a microslot and a symbol all represent a time unit during signal transmission. A radio frame, a subframe, a slot, a microslot and a symbol may also use other names that correspond to thereof, respectively. For example, one subframe may be referred to as a □transmission time interval (TTI)□, and a plurality of consecutive subframes may also be referred to as a □TTI□, and one slot or one microslot may also be referred to as a □TTI.□ That is, a subframe and/or a TTI may be a subframe (1 ms) in the existing LTE, may be a period of time shorter than 1 ms (e.g., 1 to 13 symbols), or may be a period of time longer than 1 ms. In addition, a unit indicating a TTI may also be referred to as a slot, a microslot and the like instead of a subframe.

Herein, a TTI refers to the minimum time unit of scheduling in wireless communication, for example. For example, in LTE systems, a wireless base station performs scheduling for respective user terminals that allocates radio resources (such as frequency bandwidths and transmission power that can be used in respective user terminals) in units of TTI. In addition, the definition of the TTI is not limited thereto.

The TTI may be a transmission time unit of channel-coded data packets (transport blocks), code blocks, and/or codewords, or may be a processing unit of scheduling, link adaptation and so on. In addition, when the TTI is given, a time interval (e.g., the number of symbols) mapped to transport blocks, code blocks, and/or codewords actually may also be shorter than the TTI.

In addition, when one slot or one microslot is called a TTI, more than one TTI (i.e., more than one slot or more than one microslot) may also become the minimum time unit of scheduling. Furthermore, the number of slots (the number of microslots) constituting the minimum time unit of the scheduling may be controlled.

A TTI having a time duration of 1 ms may also be referred to as a normal TTI (TTI in LTE Rel. 8-12), a standard TTI, a long TTI, a normal subframe, a standard subframe, or a long subframe, and so on. A TTI that is shorter than a normal TTI may also be referred to as a compressed TTI, a short TTI, a partial (or fractional) TTI, a compressed subframe, a short subframe, a microslot, a subslot, and so on.

In addition, a long TTI (e.g., a normal TTI, a subframe, etc.) may also be replaced with a TTI having a time duration exceeding 1 ms, and a short TTI (e.g., a compressed TTI, etc.) may also be replaced with a TTI having a TTI duration shorter than the long TTI and longer than 1 ms.

A resource block (RB) is a resource allocation unit in the time domain and the frequency domain, and may include one or more consecutive subcarriers in the frequency domain. Also, an RB may include one or more symbols in the time domain, and may be one slot, one microslot, one subframe or one TTI duration. One TTI and one subframe may be composed of one or more resource blocks, respectively. In addition, one or more RBs may also be referred to as □physical resource blocks (PRBs (Physical RBs))□, □Sub-Carrier Groups (SCGs)□, □Resource Element Groups (REGs)□, □PRG pairs□, □RB pairs□ and so on.

Furthermore, a resource block may also be composed of one or more resource elements (REs). For example, one RE may be a radio resource area of one subcarrier and one symbol.

In addition, structures of the radio frames, subframes, slots, microslots and symbols, etc. described above are simply examples. For example, configurations such as the number of subframes included in a radio frame, the number of slots of each subframe or radio frame, the number or microslots included in a slot, the number of symbols and RBs included in a slot or microslot, the number of subcarriers included in an RB, the number of symbols in a TTI, the symbol duration and the cyclic prefix (CP) duration may be variously altered.

Furthermore, the information, parameters and so on described in this specification may be represented in absolute values or in relative values with respect to specified values, or may be represented by other corresponding information. For example, radio resources may be indicated by specified indices. Furthermore, equations and the like using these parameters may be different from those explicitly disclosed in this specification.

The names used for the parameters and the like in this specification are not limited in any respect. For example, since various channels (PUCCHs (Physical Uplink Control Channels), PDCCHs (Physical Downlink Control Channels), etc.) and information elements may be identified by any suitable names, the various names assigned to these various channels and information elements are not limited in any respect.

The information, signals and the like described in this specification may be represented by using any one of various different technologies. For example, data, instructions, commands, information, signals, bits, symbols, chips, etc. possibly referenced throughout the above description may be represented by voltages, currents, electromagnetic waves, magnetic fields or particles, optical fields or photons, or any combination thereof.

In addition, information, signals and the like may be output from higher layers to lower layers and/or from lower layers to higher layers. Information, signals and the like may be input or output via a plurality of network nodes.

The information, signals and the like that are input or output may be stored in a specific location (for example, in a memory), or may be managed in a control table. The information, signals and the like that are input or output may be overwritten, updated or appended. The information, signals and the like that are output may be deleted. The information, signals and the like that are input may be transmitted to other apparatuses.

Reporting of information is by no means limited to the aspects/embodiments described in this specification, and may be implemented by other methods as well. For example, reporting of information may be implemented by using physical layer signaling (for example, downlink control information (DCI), uplink control information (UCI)), higher layer signaling (for example, RRC (Radio Resource Control) signaling, broadcast information (master information blocks (MIBs), system information blocks (SIBs), etc.), MAC (Medium Access Control) signaling), other signals or combinations thereof.

In addition, physical layer signaling may also be referred to as L1/L2 (Layer 1/Layer 2) control information (L1/L2 control signals), L1 control information (L1 control signal) and the like. Furthermore, RRC signaling may also be referred to as □RRC messages□, for example, RRC connection setup messages, RRC connection reconfiguration messages, and so on. Furthermore, MAC signaling may be reported by using, for example, MAC control elements (MAC CEs).

Furthermore, notification of prescribed information (for example, notification of □being X□) is not limited to being performed explicitly, and may be performed implicitly (for example, by not performing notification of the prescribed information or by notification of other information).

Decision may be performed by a value (0 or 1) represented by 1 bit, or by a true or false value (boolean value) represented by TRUE or FALSE, or by a numerical comparison (e.g., comparison with a prescribed value).

Software, whether referred to as □software□, □firmware□, □middleware□, □microcode□ or □hardware description language□, or called by other names, should be interpreted broadly to mean instructions, instruction sets, code, code segments, program codes, programs, subprograms, software modules, applications, software applications, software packages, routines, subroutines, objects, executable files, execution threads, procedures, functions and so on.

In addition, software, commands, information, etc. may be transmitted and received via a transport medium. For example, when software is transmitted from web pages, servers or other remote sources using wired technologies (coaxial cables, fibers, twisted pairs, Digital Subscriber Lines (DSLs), etc.) and/or wireless technologies (infrared ray, microwave, etc.), these wired technologies and/or wireless technologies are included in the definition of the transport medium.

The terms □system□ and □network□ used in this specification are used interchangeably.

In this specification, terms like □Base Station (BS)□, □wireless base station□, □eNB□, □gNB□, □cell□, □sector□, □cell group□, □carrier□ and □component carrier□ may be used interchangeably. The base station is sometimes referred to as terms such as a fixed station, a NodeB, an eNodeB (eNB), an access point, a transmitting point, a receiving point, a femto cell, a small cell, etc.

A base station is capable of accommodating one or more (for example, three) cells (also referred to as sectors). In a case where the base station accommodates a plurality of cells, the entire coverage area of the base station may be divided into a plurality of smaller areas, and each smaller area may provide communication services by using a base station sub-system (for example, a small base station for indoor use (a Remote Radio Head (RRH)). Terms like □cell□ and □sector□ prefer to a part of or an entirety of the coverage area of a base station and/or a sub-system of the base station that provides communication services in this coverage.

In this specification, terms such as □Mobile Station (MS)□, □user terminal□, □User Equipment (UE)□, and □terminal□ may be used interchangeably. The mobile station is sometimes referred by those skilled in the art as a user station, a mobile unit, a user unit, a wireless unit, a remote unit, a mobile device, a wireless device, a wireless communication device, a remote device, a mobile user station, an access terminal, a mobile terminal, a wireless terminal, a remote terminal, a handset, a user agent, a mobile client, a client, or some other appropriate terms.

Furthermore, the wireless base station in this specification may also be replaced with a user terminal. For example, for a structure in which communication between a wireless base station and a user terminal is replaced with communication between a plurality of user terminals (Device-to-Device, D2D), respective manners/embodiments of the present disclosure may be applied. At this time, functions provided by the wireless base station described above may be regarded as functions provided by the user terminals. Furthermore, the words □uplink□ and □downlink□ may also be replaced with □side□. For example, an uplink channel may be replaced with a side channel.

Also, the user terminal in this specification may be replaced with a wireless base station. At this time, functions provided by the above user terminal may be regarded as functions provided by the wireless base station.

In this specification, specific actions configured to be performed by the base station sometimes may be performed by its upper nodes in certain cases. Obviously, in a network composed of one or more network nodes having base stations, various actions performed for communication with terminals may be performed by the base stations, one or more network nodes other than the base stations (for example, Mobility Management Entities (MMEs), Serving-Gateways (S-GWs), etc., may be considered, but not limited thereto)), or combinations thereof.

The respective manners/embodiments described in this specification may be used individually or in combinations, and may also be switched and used during execution. In addition, orders of processes, sequences, flow charts and so on of the respective manners/embodiments described in this specification may be re-ordered as long as there is no inconsistency. For example, although various methods have been described in this specification with various units of steps in exemplary orders, the specific orders as described are by no means limitative.

The manners/embodiments described in this specification may be applied to systems that utilize LTE (Long Term Evolution), LTE-A (LTE-Advanced), LTE-B (LTE-Beyond), SUPER 3G, IMT-Advanced, 4G (4th generation mobile communication system), 5G (5th generation mobile communication system), FRA (Future Radio Access), New-RAT (New Radio Access Technology), NR (New Radio), NX (New radio access), FX (Future generation radio access), GSM® (Global System for Mobile communications), CDMA 2000, UMB (Ultra Mobile Broadband), IEEE 802.11 (Wi-Fi®), IEEE 802.16 (WiMAX®), IEEE 802.20, UWB (Ultra-WideBand), Bluetooth® and other appropriate wireless communication methods, and/or next-generation systems that are enhanced based on them.

Terms such as □based on□ as used in this specification do not mean □based on only□, unless otherwise specified in other paragraphs. In other words, terms such as □based on□ mean both □based on only□ and □at least based on.□

Any reference to units with designations such as □first□, □second□ and so on as used in this specification does not generally limit the quantity or order of these units. These designations may be used in this specification as a convenient method for distinguishing between two or more units. Therefore, reference to a first unit and a second unit does not imply that only two units may be employed, or that the first unit must precedes the second unit in several ways.

Terms such as □deciding (determining)□ as used in this specification may encompass a wide variety of actions. The □deciding (determining)□ may regard, for example, calculating, computing, processing, deriving, investigating, looking up (e.g., looking up in a table, a database or other data structures), ascertaining, etc. as performing the □deciding (determining)□. In addition, the □deciding (determining)□ may also regard receiving (e.g., receiving information), transmitting (e.g., transmitting information), inputting, outputting accessing (e.g., accessing data in a memory), etc. as performing the □deciding (determining)□. In addition, the □deciding (determining)□ may further regard resolving, selecting, choosing, establishing, comparing, etc. as performing the □deciding (determining)□. That is to say, the □deciding (determining)□ may regard certain actions as performing the □deciding (determining)□.

As used herein, terms such as □connected□, □coupled□, or any variation thereof mean any direct or indirect connection or coupling between two or more units, and may include the presence of one or more intermediate units between two units that are □connected□ or □coupled□ to each other. Coupling or connection between the units may be physical, logical or a combination thereof. For example, □connection□ may be replaced with □access.□ As used in this specification, two units may be considered as being □connected□ or □coupled□ to each other by using one or more electrical wires, cables and/or printed electrical connections, and, as a number of non-limiting and non-inclusive examples, by using electromagnetic energy having wavelengths in the radio frequency region, microwave region and/or optical (both visible and invisible) region.

When terms such as □including□, □comprising□ and variations thereof are used in this specification or the claims, these terms, similar to the term □having□, are also intended to be inclusive. Furthermore, the term □or□ as used in this specification or the claims is not an exclusive or.

Although the present disclosure has been described in detail above, it should be obvious to a person skilled in the art that the present disclosure is by no means limited to the embodiments described in this specification. The present disclosure may be implemented with various modifications and alterations without departing from the spirit and scope of the present disclosure defined by the recitations of the claims. Consequently, the description in this specification is for the purpose of illustration, and does not have any limitative meaning to the present disclosure.

1. A method performed by a terminal, the method comprising:
transmitting access information of the terminal;
receiving response information of a base station to the access information, wherein the response information includes acknowledgement information of the base station to the access information;
transmitting service information after receiving the response information to the access information, wherein the service information includes data information.

2-20. (canceled)

21. A terminal comprising:
a transmitting unit configured to transmit access information of the terminal;
a receiving unit configured to receive response information of a base station to the access information, wherein the response information includes acknowledgement information of the base station to the access information,
the transmitting unit further configured to transmit service information after the receiving unit receives the response information to the access information, wherein the service information includes data information.

22. A base station comprising:
a receiving unit configured to receive access information of a terminal;
a decoding unit configured to decode the access information of the terminal;
a transmitting unit configured to transmit response information if the decoding unit decodes the access information of the terminal correctly, wherein the response information includes acknowledgement information of the base station to the access information,
the receiving unit further configured to receive service information after the transmitting unit transmits the response information, wherein the service information includes data information.

23. The terminal of claim 21, wherein
the access information includes a preamble code.

24. The terminal of claim 23, wherein
the service information further includes uplink data control information.

25. The terminal of claim 23, wherein the transmitting unit is configured to transmit uplink data control information, the receiving unit is configured to receive response information of the base station to the uplink data control information, the response information including acknowledgement information of the base station to the uplink data control information, the transmitting unit is further configured to transmit the service information after receiving unit receives the response information to the uplink data control information.

26. The terminal of claim 21, wherein
the access information includes uplink data control information.

27. The terminal of claim 21, further comprising a processing unit configured to determine a periodic information-receiving window, the receiving unit further configured to receive the response information of the base station to the access information in a first information-receiving window after transmitting the access information of the terminal.

28. The terminal of claim 21, wherein the receiving unit is configured to determine radio resources carrying the response information based on at least one of identification information of the terminal and information on radio resources for transmitting uplink data control information, and to receive the response information of the base station to the access information on the radio resources.

29. The terminal of claim 21, wherein
the access information further includes first scheduling information for the service information,
the first scheduling information includes at least one of modulation and coding information for the service information, information on the number of times of retransmissions for the service information, transmission power control information for the service information, signature information for the service information, reference signal information for the service information, and radio resource information for the service information.

30. The terminal of claim 29, wherein
the response information further includes modified scheduling information.

31. The terminal of claim 29, wherein
the response information further includes second scheduling information.

32. The base station of claim 22, wherein
the access information includes a preamble code.

33. The base station of claim 32, wherein
the service information further includes uplink data control information.

34. The base station of claim 32, wherein the receiving unit is configured to receive uplink data control information, the decoding unit is configured to decode the uplink data control information, and the transmitting unit is configured to transmit response information of the uplink data control information if the uplink data control information is decoded correctly, wherein the response information to the uplink data control information includes acknowledgement information of the base station to the uplink data control information, the receiving unit is further configured to receive the service information after the transmitting unit transmits the response information to the uplink data control information.

35. The base station of claim 22, wherein
the access information includes uplink data control information.

36. The base station of claim 22, further comprising:
a processing unit configured to determine a periodic information-receiving window;
wherein the transmitting unit is configured to transmit the response information in a first information-receiving window after the receiving unit receives the access information of the terminal.

37. The base station of claim 22, wherein
the access information further includes first scheduling information for the service information,
the first scheduling information includes at least one of modulation and coding information for the service information, information on the number of times of retransmissions for the service information, transmission power control information for the service information, signature information for the service information, reference signal information for the service information, and radio resource information for the service information.

38. The base station of claim 37, further comprising:
a processing unit configured to generate modified scheduling information according to the first scheduling information,
wherein the response information further includes the modified scheduling information.

39. The base station of claim 37, further comprising:
a processing unit configured to generate second scheduling information,
wherein the response information further includes the second scheduling information.
